(19) United States
(12) Patent Application Publication
(10) Pub. No.: US 2010/0057319 A1
(43) Pub. Date: Mar. 4, 2010

(54) INVERTED TWO-WHEEL GUIDED VEHICLE AND CONTROL METHOD THEREFOR

(76) Inventors: Toshio Inaji, Osaka (JP); Soichiro Fujioka, Osaka (JP); Yoshihiko Matsukawa, Nara (JP)

Correspondence Address: WENDEROTH, LIND & PONACK L.L.P., 1030 15th Street, N.W., Suite 400 East, Washington, DC, 20005-1503, US

(21) Appl. No.: 12/515,353

(22) PCT Filed: Jul. 25, 2008
(86) PCT No.: PCT/JP2008/001993

§ 371 Date: May 18, 2009

(30) Foreign Application Priority Data
Aug. 28, 2007 (JP) 2007-220563

(51) Int. Cl. B62K 11/00; G06F 19/00

(52) U.S. Cl. 701/70; 180/218

(57) ABSTRACT

An inverted two-wheel guided vehicle is provided with a vehicle body 4 including a loading platform, a carriage 5 supported on wheels 1a, 1b, a moving mechanism 7 for displacing relative positions of the vehicle body 4 and the carriage 5, an inclination sensor 6 for detecting the posture of the vehicle body 4, and a controller 9 for controllably driving the wheels 1a, 1b and the moving mechanism 7. Since a posture control can be executed such that a seat 8 atop the vehicle body 4 is constantly horizontal by displacing the moving mechanism forward and backward even for a slope or a step in a travel path, a stable travel can be realized by preventing the collapse of baggage piles and giving no discomfort to a loaded person.

### FIELD OF TECHNOLOGY

The present invention relates to a guided vehicle for transporting baggage or a person and particularly to an inverted two-wheel guided vehicle provided with mechanism technology and control technology for stably transporting baggage or a person by holding an originally unstable vehicle body in equilibrium. The present invention also relates to an inverted two-wheel guided vehicle capable of traveling in such a stable posture as to constantly horizontally hold a loading platform loaded with a heavy load such as baggage or a person loaded also upon climbing up or down a slope using the inverted two-wheel guided vehicle. The present invention further relates to an inverted two-wheel guided vehicle capable of moving over a step and traveling in a stable posture even if the step is present in a travel path of the inverted two-wheel guided vehicle.

### DESCRIPTION OF THE BACKGROUND ART

There has been conventionally known an inverted two-wheel guided vehicle for transporting baggage or a person while holding an unstable vehicle body in equilibrium by control technology (see, for example, patent literature 1). FIGS. 27 and 28 show a conventional inverted two-wheel guided vehicle disclosed in this patent literature 1.

In FIGS. 27 and 28, a pair of wheels 102, 103 are fixed to the opposite ends of an axle 101 and a vehicle body 104 in the form of a rectangular frame is inclinably supported on the axle 101. A supporting shaft 105 is rotatably mounted in an upper part of the vehicle body 101, a posture control arm 106 is fixed to hang down in the center of the supporting shaft 105 and a weight 106a is mounted at the bottom end of the posture control arm 106.

A wheel driving motor 107 capable of rotating in forward and reverse directions is mounted in the vehicle body 104 immediately below the weight 106a, and a speed reducing gear train 108 is interposed between a drive shaft 107a of the motor 107 and the axle 101. Thus, a torque of the wheel driving motor 107 is transmitted to the axle 101 after being speed reduced, thereby rotating the wheels 102, 103 in the forward or reverse direction. A posture control arm driving motor 109 capable of rotating in forward and reverse directions is mounted immediately above the supporting shaft 105 in the vehicle body 104, and a speed reducing gear train 110 is interposed between a drive shaft 109a of the motor 109 and the supporting shaft 105. Thus, a torque of the posture control arm driving motor 109 is transmitted to the supporting shaft 105 after being speed reduced, thereby pivoting the posture control arm 106 forward or backward.

A first rotary encoder 111 is provided on one side surface of the vehicle body 104, and a rotary shaft 111a thereof is set on an extension of the axle 101. A pair of contact pieces 112, 113 are so mounted on the rotary shaft 111a as to be orthogonal to each other, and the leading ends thereof are held in slidable contact with a floor surface. In this way, an angle of inclination of the vehicle body 104 with respect to a vertical line can be detected. A second rotary encoder 114 is mounted on the wheel driving motor 107 and a third rotary encoder 115 is mounted on the posture control arm driving motor 109, whereby angles of rotation of the both motors 107, 109, i.e. angles of rotation of the wheels 102, 103, an angle of inclination with respect to a vertical line and an angle of the posture control arm 106 with respect to the vehicle body 104 are detected. A control computer 116 including a microcomputer is mounted in a lower part of the vehicle body 104, and detection signals from the above respective rotary encoders 111, 114 and 115 are inputted thereto.

The control computer 116 calculates control torques for the wheel driving motor 107 and the posture control arm driving motor 109 based on the input signals, and instructs operations corresponding to these control torques to the wheel driving motor 107 and the posture control arm driving motor 109. Specifically, since the angles detected by the encoders 111, 114 and 115 serve as state variables indicating the posture of a robot (inverted two-wheel guided vehicle), the control torques for the wheel driving motor 107 and the posture control arm driving motor 109 are obtained by applying a dynamic model of the robot and multiplying these values by a state feedback gain calculated as an optimal regulator problem for stabilizing the posture beforehand. If the vehicle body 104 is inclined as a result, the wheels 102, 103 move in an inclining direction of the vehicle body 104 and the posture control arm 106 is rotated toward a side opposite to the inclining direction of the vehicle body 104 to reliably restore the horizontal balance of the vehicle body 104.

An inverted guided vehicle disclosed in patent literature 2 is also known as another conventional inverted guided vehicle. FIG. 29 is a view showing the conventional inverted guided vehicle disclosed in patent literature 2.

In FIG. 29, a chair-shaped transporting apparatus 331 is provided with a substantially spherical ball-shaped rotary body 337, a housing 333 provided atop the ball-shaped rotary body 337, a seat 334 for holding a vehicle operator, a first counterweight portion 349c and a second counterweight portion 349b for changing the center of gravity position of the chair-shaped transporting apparatus 331.

Unillustrated driver and controller for driving the ball-shaped rotary body 337 and an unillustrated inclination angle sensor for detecting the posture (angle of inclination) of the housing 333 are provided in the housing 333. The inclination angle sensor detects a signal corresponding to an angle of inclination of the housing 333 with respect to a perpendicular, the controller outputs a drive signal to the driver in accordance with the signal corresponding to the angle of inclination of the housing 333 and the driver rotates the substantially spherical rotary body 337, whereby the posture and movement of the housing 333 are controlled.

When the vehicle operator moves his weight by having a forward inclined posture, a backward inclined posture or the like, the movement of the center of gravity is precisely transmitted to the housing 333 and the chair-shaped transporting apparatus 333 can travel in a direction intended by the vehicle operator, coupled with the above posture control.

The first counterweight portion 349c is so arranged to move the weight in an x-axis direction and the second counterweight portion 349b is so arranged as to move the weight in a y-axis direction. Thus, the center of gravity position can be two-dimensionally changed by the first and second counterweight portions 349c, 349b.

By the above construction, in response to the inclination of the housing 333 caused when the seated position of the vehicle operator is displaced from a planned position and the center of gravity of the vehicle operator and that of the transporting apparatus 331 do not coincide, the controller can output a counterweight drive signal in accordance with the signal corresponding to the angle of inclination of the housing 333 and restore the horizontal balance of the housing 333.

However, in the conventional constructions disclosed in the above patent literatures 1, 2, the horizontal balance of the vehicle body is restored by moving the position of the weight 106a mounted at the leading end of the posture control arm 106 or by moving the first and second counterweight portions 349c, 349b integrated in the vehicle body. Thus, in the case of loading baggage or a person whose mass is equal to or larger than the counterweight, there was a problem of being unable to restore the horizontal balance of the vehicle body only by moving the weight 106a or the first and second counterweight portions 349c, 349b. Further, if an attempt is made to make the mass of the weight or the counterweights sufficiently larger, the weight of the vehicle body increases, which has presented a problem of hindering kinematic performance as a movable body.

In the case of employing a weight or a counterweight with a minimized mass, a movable range needs to be maximally widened in order to increase the moment of the counterweight by minimizing the mass thereof. It has presented a problem of being, in fact, difficult because of the size of the shape to design such a counterweight mechanism capable of dealing with a displacement of the center of gravity.

Further, since no control is executed for a vertical displacement such as an upward or downward movement to or from a step present in a travel path in the inverted guided vehicles disclosed in the above patent literatures 1, 2, there has been a problem that the wheels cannot satisfactorily follow the step and the guided vehicle may tip over.

### Patent Literature 1:

Japanese Unexamined Patent Publication No. S63-305082

### Patent Literature 2:

Japanese Unexamined Patent Publication No. 2004-129435

### DISCLOSURE OF THE INVENTION

An object of the present invention is to provide an inverted two-wheel guided vehicle which balances an originally unstable vehicle body by a control and is capable of restoring horizontal balance by automatically moving the center of gravity position of the entire vehicle body loaded with baggage or a person to the position of an axle even if the center of gravity of the loaded baggage or person and that of the vehicle body are displaced.

Another object of the present invention is to provide an inverted two-wheel guided vehicle which balances an originally unstable vehicle body by a control and is capable of moving over a step in a stable posture by executing a control for a vertical displacement.

One aspect of the present invention is directed to an inverted two-wheel guided vehicle, comprising a vehicle body including a loading platform capable of carrying baggage or a person; a carriage supported on two wheels coaxially arranged while being spaced apart; a moving mechanism provided between the vehicle body and the carriage for displacing relative positions of the vehicle body and the carriage in a traveling direction of the carriage; an inclination detector for detecting the posture of the vehicle body with respect to a vertical direction; a travel detector for detecting a traveling state of the carriage; a first actuator for causing the two wheels to respectively generate rotational forces; a second actuator for causing the vehicle body to generate a thrust via the moving mechanism; a drive controller for outputting a torque command and a thrust command to the first actuator and the second actuator; a target commanding section for generating a target command value for at least one of the position and speed of the carriage; a deviation compensating section, to which the target command value and detection signals of the inclination detector and the travel detector are inputted to generate a deviation compensation signal based on a deviation between the target command value and the detection signals; and a stabilization compensating section, to which at least the respective detection signals of the inclination detector and the travel detector are inputted to generate a stabilization signal used to control the posture of the vehicle body, wherein the deviation compensating section generates the deviation compensation signal using a processing of at least doubly integrating a signal based on the detection signal of the inclination detector with respect to time; and the drive controller generates the torque command and the thrust command in accordance with the deviation compensation signal and the stabilization signal.

By the above construction, in the inverted two-wheel guided vehicle in which the originally unstable vehicle body is balanced by a control, the horizontal balance of the loading platform can be maintained by the moving mechanism automatically moving the center of gravity position of the entire vehicle body loaded with baggage or a person to the position of an axle of the guided vehicle even if the center of gravity of the loaded baggage or person is displaced from the center of gravity of the vehicle body.

Another aspect of the present invention is directed to an inverted two-wheel guided vehicle, comprising a vehicle body including a loading platform capable of carrying baggage or a person; a carriage supported on two wheels coaxially arranged while being spaced apart; a moving mechanism provided between the vehicle body and the carriage for displacing relative positions of the vehicle body and the carriage in a traveling direction of the carriage; an inclination detector for detecting the posture of the vehicle body with respect to a vertical direction; a travel detector for detecting a traveling state of the carriage; a vertical acceleration detector for detecting vertical acceleration of the carriage; a first actuator for causing the two wheels to respectively generate rotational forces; a second actuator for causing the vehicle body to generate a thrust via the moving mechanism; and a controller for outputting a torque command and a thrust command to the first actuator and the second actuator, wherein the controller controls a rotational torque of the first actuator and a thrust of the second actuator according to a detection signal of the inclination detector and a detection signal of the travel detector and adjusts the thrust of the second actuator according to the magnitude of the acceleration detected by the vertical acceleration detector.

By the above construction, in the inverted two-wheel guided vehicle in which the originally unstable vehicle body is balanced by a control, a control can be executed for a vertical displacement and a step can be moved over in a stable posture.

### BRIEF DESCRIPTION OF THE DRAWINGS

FIG. 1 is a perspective view of an inverted two-wheel guided vehicle in a first embodiment of the invention,

FIG. 3 is a front view of the inverted two-wheel guided vehicle shown in FIG. 1,

FIG. 4 is a diagram showing the definition of constants of the inverted two-wheel guided vehicle in the first embodiment of the invention,

FIG. 5 is a block diagram showing an example of a controller of the inverted two-wheel guided vehicle in the first embodiment of the invention,

FIG. 6A trough FIG. 6E are time waveform graphs showing an uphill operation of the inverted two-wheel guided vehicle in the first embodiment of the invention,

FIG. 7A trough FIG. 7D are time waveform graphs showing an uphill operation of a conventional inverted two-wheel guided vehicle including no moving mechanism,

FIG. 8 is a time waveform graph of a speed command used in operation simulations of the inverted two-wheel guided vehicles of FIG. 6A trough FIG. 7D,

FIG. 9 is a section showing the shape of a slope used in the operation simulations of the inverted two-wheel guided vehicles of FIG. 6A trough FIG. 7D,

FIG. 10 is a view diagrammatically showing a forward inclined posture of the vehicle body based on the simulation result during the uphill operation of the inverted two-wheel guided vehicle of FIG. 7A trough FIG. 7D,

FIG. 11 is a view diagrammatically showing a forward inclined posture of the vehicle body based on the simulation result during the uphill operation of the inverted two-wheel guided vehicle of FIG. 6A trough FIG. 6E,

FIG. 12 is a block diagram showing an example of a deviation compensator used in a controller of the inverted two-wheel guided vehicle in the first embodiment of the present invention,

FIG. 13 is a block diagram of a deviation compensator as a comparative example used in the simulation,

FIG. 14A trough FIG. 14E are time waveform graphs showing a simulation result when the deviation compensator of the comparative example shown in FIG. 13 was used,

FIG. 15 is a section showing the shape of a step used in an operation simulation of the inverted two-wheel guided vehicle,

FIG. 16A trough FIG. 16D are time waveform graphs showing a simulation result of a step moving-over operation of the conventional inverted two-wheel guided vehicle including no moving mechanism,

FIG. 17A trough FIG. 17E are time waveform graphs showing a simulation result of a step moving-over operation of the inverted two-wheel guided vehicle in the first embodiment of the present invention,

FIG. 18 is a diagram showing the simulation result of the step moving-over operation of the conventional inverted two-wheel guided vehicle of FIG. 16A trough FIG. 16D,

FIG. 19 is a diagram showing the simulation result of the step moving-over operation of the inverted two-wheel guided vehicle of FIG. 17A trough FIG. 17E,

FIG. 20 is a block diagram showing an example of a controller of an inverted two-wheel guided vehicle in a second embodiment of the invention,

FIG. 21 is a block diagram showing a more specific example of a signal converter constituting the controller of FIG. 20,

FIG. 22A trough FIG. 22E are time waveform graphs showing a simulation result of a step moving-over operation as a comparative example in the case where the inverted two-wheel guided vehicle including the moving mechanism is not provided with a vertical acceleration sensor,

FIG. 23A trough FIG. 23E are time waveform graphs showing a simulation result of a step moving-over operation of the inverted two-wheel guided vehicle in the second embodiment of the present invention,

FIG. 24 is a time waveform graph of a pulse signal generated by a pulse generator when a vertical acceleration detector detects vertical acceleration,

FIG. 25 is a block diagram showing another example of the controller of the inverted two-wheel guided vehicle in the second embodiment of the invention,

FIG. 26 is a block diagram showing a more specific example of a signal converter constituting the controller shown in FIG. 25,

FIG. 27 is a perspective view showing a conventional inverted two-wheel guided vehicle to be held in equilibrium by an arm and a weight at the leading end of the arm,

FIG. 28 is a side view of the inverted two-wheel guided vehicle shown in FIG. 27, and

FIG. 29 is a perspective view showing counterweights incorporated in a conventional chair-shaped vehicle.

### BEST MODES FOR EMBODYING THE INVENTION

Hereinafter, embodiments of the present invention are described with reference to the drawings.

### First Embodiment

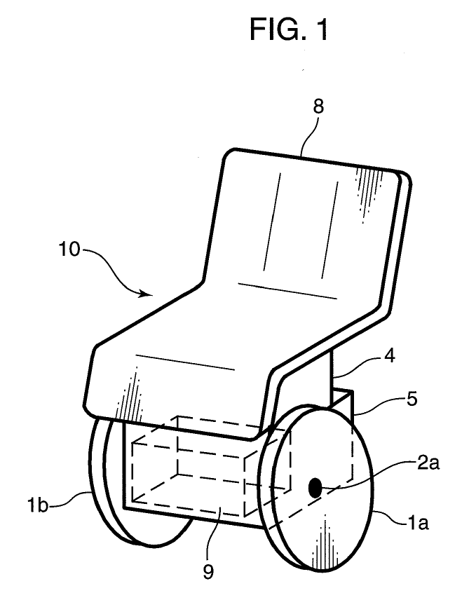

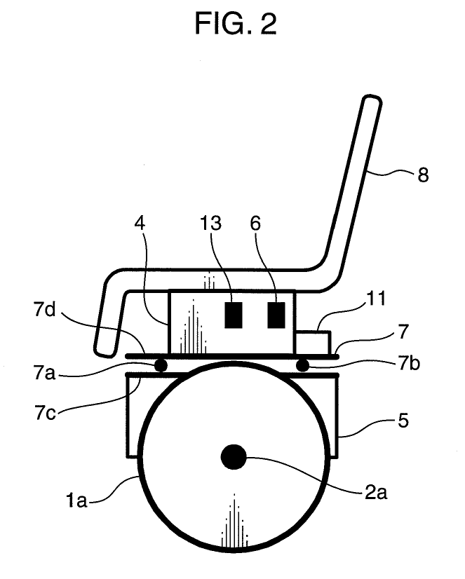

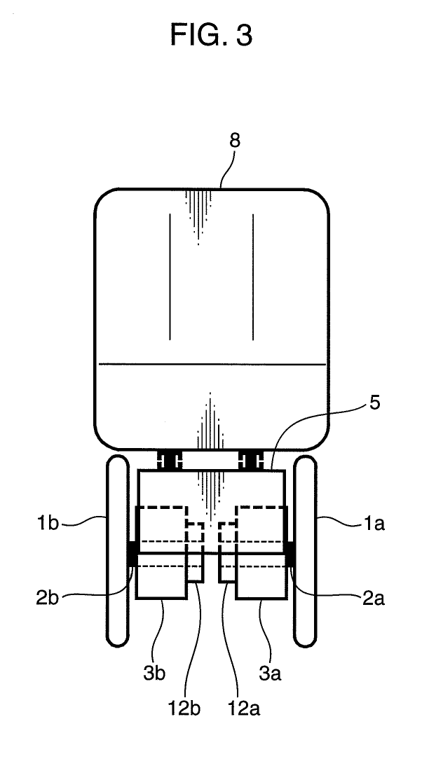

FIG. 1 is a perspective view of an inverted two-wheel guided vehicle in a first embodiment of the invention, FIG. 2 is a side view of this inverted two-wheel guided vehicle, and FIG. 3 is a front view of this inverted two-wheel guided vehicle.

In FIGS. 1 to 3, two wheels 1a, 1b are coaxially arranged and respectively connected with two axles 2a, 2b. Two first actuators 3a, 3b include motors and the like and are respectively connected with the two axles 2a, 2b to independently drive the two wheels 1a, 1b. A carriage 5 holds the first actuators 3a, 3b supported on the axles 2a, 2b so as to be rotatable about the axles 2a, 2b. The first actuators 3a, 3b are controlled by a controller 9 for controlling a traveling movement of an inverted two-wheel guided vehicle 10, thereby causing the inverted two-wheel guided vehicle 10 to travel and holding a vehicle body 4 in equilibrium.

An inclination sensor 6 constitutes an inclination detector for detecting the posture, i.e. an angle of inclination of the vehicle body 4. A gyro sensor is used as an example of the inclination sensor 6. Encoders 12a, 12b are mounted on the first actuators 3a, 3b or on the wheels 1a, 1b and constitute a travel detector for detecting a traveling state of the carriage 5. A vertical acceleration sensor 13 constitutes a vertical acceleration detector and detects the vertical acceleration of the inverted two-wheel guided vehicle 10. The vertical acceleration sensor 13 may be omitted in the case of not detecting the vertical acceleration.

A moving mechanism 7 is provided between the vehicle body 4 and the carriage 5 of this inverted two-wheel guided vehicle 10 and constructed such that relative positions of the vehicle body 4 and the carriage 5 are displaceable in a traveling direction of the inverted two-wheel guided vehicle 10 by a second actuator 11. In the moving mechanism 7, rollers 7a and 7b are arranged between loading surfaces 7c and 7d for the purpose of reducing friction, and the relative positions of the carriage 5 and the vehicle body 4 are freely displaceable by the second actuator 11. The second actuator 11 is constructed by a linear motor capable of linear motions or a rotary motor and a translating mechanism for translating a rotational motion into a linear motion or the like.

This inverted two-wheel guided vehicle 10 includes a seat 8 as an example of a loading platform, on which a person can sit, atop the vehicle body 4. An example of the loading platform is not particularly limited to this example, and a baggage platform suitable for loading baggage thereon may be used instead of the seat 8 in the case of loading the baggage.

By the above construction, the inclination sensor 6 detects a gravity direction and an inclined posture of the vehicle body 4 with respect to the gravity direction and outputs a detection signal to the controller 9. Based on the detected inclination, the controller 9 gives suitable torque command and thrust command to the first actuators 3a, 3b and the second actuator 11 to make such an adjustment as to hold the vehicle body 4 in equilibrium. Angles of rotation of the wheels 1a, 1b can be measured by counting pulses of the encoders 12a, 12b mounted on the first actuators 3a, 3b.

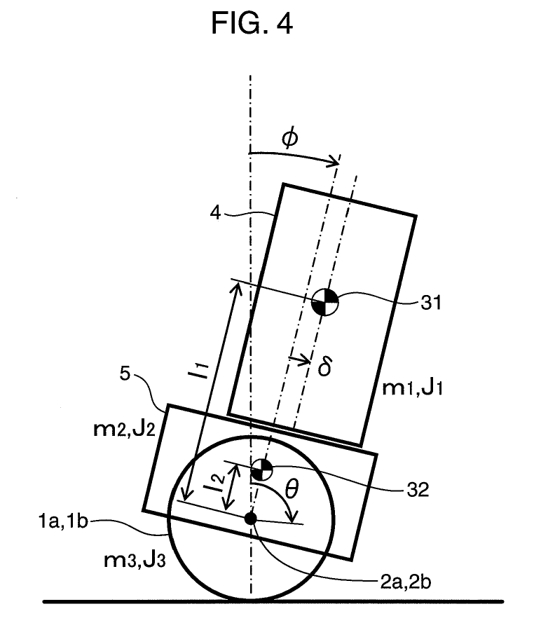

Next, a control system of the inverted two-wheel guided vehicle according to this embodiment is described. FIG. 4 is a diagram showing the definition of constants of the inverted two-wheel guided vehicle in the first embodiment of the present invention.

As shown in FIG. 4, it is defined that φ denotes an angle of inclination of the vehicle body 4; 0 an angle of rotation of the wheels 1a, 1b; δ a relative displacement amount of the vehicle body 4 from the carriage 5 by the moving mechanism 7; m1 the mass of the vehicle body 4, J1 the moment of inertia of the vehicle body 4, m2 the mass of the carriage 5; J2 the moment of inertia of the carriage 5; m3 the mass of the wheels 1a, 1b (since there are two wheels 1a, 1b, m3 is double the mass of one wheel); J3 the moment of inertia of the wheels 1a, 1b (since there are two wheels 1a, 1b, J3 is double the moment of inertia of one wheel); δ the radius of the wheels 1a, 1b; I1 the height (distance) of a center of gravity 31 of the vehicle body 4 from the axial centers of the axles 2a, 2b; and I2 the height (distance) of a center of gravity 32 of the carriage 5 from the axial centers of the axles 2a, 2b.

In FIG. 4, increases in the mass and the moment of inertia caused by the loading of baggage or a person on the loading platform or the seat 8 are included in the mass m1 of the vehicle body 4 and the moment of inertia J1. The rotations of the first actuators 3a, 3b are transmitted to the wheels 1a, 1b via unillustrated speed reducing mechanisms. The moments of inertia of the first actuators 3a, 3b when seen from the wheels 1a, 1b (n²×Jm if Jm and n denote the moment of inertia of the first actuator and a speed reduction ratio) is included in the moment of inertia J3 of the wheels 1a, 1b.

It is also assumed that T denotes a rotational torque transmitted from the first actuators 3a, 3b to the wheels 1a, 1b via the speed reducing mechanisms (n×tm if tm and n denote a torque generated by the first actuators and the speed reduction ratio); F a thrust of the second actuator 11 acting on the moving mechanism 7; μt a viscous friction coefficient in the rotation of the wheels 1a, 1b; and μs a viscous friction coefficient of the moving mechanism 7.

These constants of the inverted two-wheel guided vehicle 10 are determined as follows.

| | |
|---|---|
| Mass of the vehicle body 4: | m1 = 55 kg |
| Mass of the carriage 5: | m2 = 15 kg |
| Mass of the wheels 1a, 1b | m3 = 3 × 2 kg |
| Moment of inertia of the vehicle body 4: | J1 = 4 kg · m² |
| Moment of inertia of the carriage 5: | J2 = 0.2 kg · m² |
| Moment of inertia of the wheels 1a, 1b: | J3 = 0.1 × 2 kg · m² |
| Radius of the wheels 1a, 1b: | r = 0.2 m |
| Center of gravity distance of the vehicle | I1 = 0.3 m |
| body 4: | |
| Center of gravity distance of the carriage 5: | I2 = 0.1 m |
| Viscous friction coefficient of the wheels: | μt = 0.0001N · m/(rad/s) |
| Viscous friction coefficient of the moving | μs = 0.0001N/(m/s) |
| mechanism: | |
| Gravitational acceleration: | g = 9.8 m/s² |

Using the above constants, an equation of motion of the inverted two-wheel guided vehicle shown in FIG. 4 is comprised of the following three equations of (1), (2) and (3). However, if the inverted two-wheel guided vehicle 10 is in an inverted state, linearization is applied using approximate equations of equations (4) and (5) assuming that the angle of inclination φ of the vehicle body 4 is sufficiently small. It should be noted that [·] above variables in FIGS. and the equations denotes first order temporal differentiation of the variables and [··] above variables in figures and the equations denotes second order temporal differentiation of the variables.

(J1+J2+m1·l1²+m2·l2²)·\ddot{φ}+(m1·r·l1+m2·r·l2)·\ddot{θ}+m1·l1·\ddot{δ}+μt·\dot{φ}−μt·\dot{θ}−(m1·l1+m2·l2)·g·φ−m1·g·δ=−T (1)

(m1·l1+m2·l2)·r·\ddot{φ}+{J3+(m1+m2+m3)·r²}\ddot{θ}+m1·r·\ddot{δ}−μt·\dot{φ}+μt·\dot{θ}=T (2)

m1·l1·\ddot{φ}+m1·r·\ddot{θ}+m1·\ddot{δ}+μs·\dot{δ}−m1·g·φ=F (3)

cos φ≈1 (4)

sin φ≈φ (5)

If state variables are defined as in equation (6) and inputs are defined as in equation (7), equations (1), (2) and (3) can be organized into equation (8). It should be noted that T written in equations (6) and (7) denote vector transposition.

x=[φ θ δ \dot{φ} \dot{θ} \dot{δ}]^{T} (6)

u=[T F]^{T} (7)

\dot{x}=A·x+B·u (8)

Here, the angle of inclination φ of the vehicle body 4 is measurable by the inclination sensor 6 and the angle of rotation θ of the wheels 1a, 1b is measurable by the encoders 12a, 12b. Further, the relative displacement amount δ of the moving mechanism 7 may be measured by mounting a position sensor on the moving mechanism 7 to directly measure a displacement of the vehicle body 4 and the carriage 5 or may be estimated from measurable two state variables (φ, θ) and two inputs (T, F) based on the equation of state (8) by disposing a generally used state observer. If the state observer is disposed, it is not necessary to especially provide the moving mechanism 7 with the position sensor to measure the displacement 6 of the vehicle body 4 and the carriage 5, wherefore a cost reduction of the apparatus can be promoted.

From the above, all the state variables of equation (6) can be measured and the inverted two-wheel guided vehicle 10 can be stabilized in an inverted state by determining a suitable state feedback gain by an optimal regulator method.

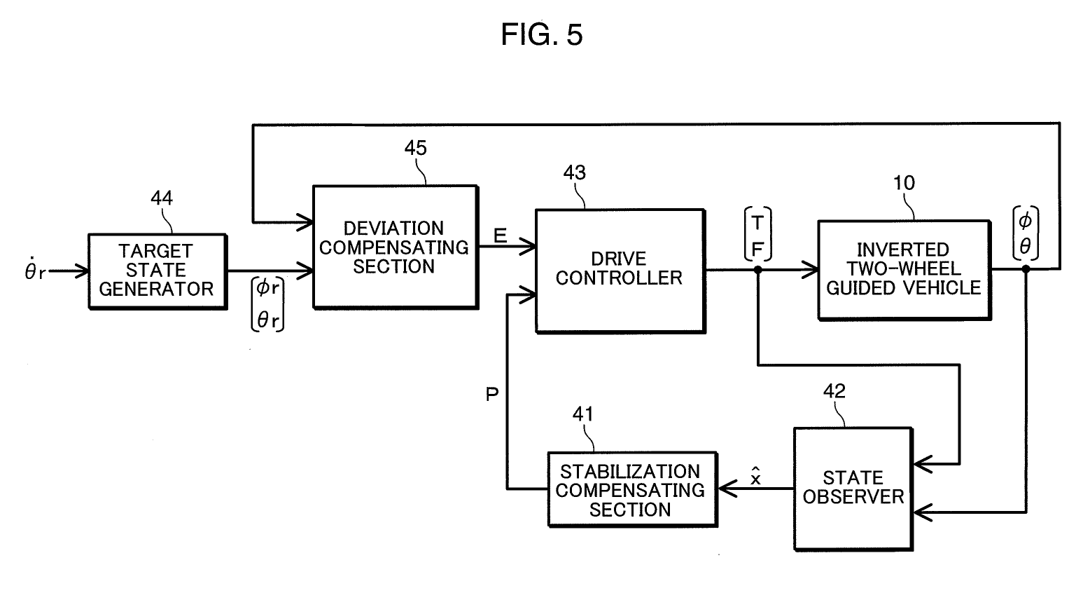

FIG. 5 is a block diagram showing an example of the controller 9 of the inverted two-wheel guided vehicle 10 in the first embodiment of the present invention. In FIG. 5, the controller 9 includes a stabilization compensator 41, a state observer 42, a drive controller 43, a target state generator 44 and a deviation compensator 45. In FIG. 5, the inverted two-wheel guided vehicle 10 is shown as an object to be controlled in the block diagram and the first actuators 3a, 3b, the second actuator 11, the inclination sensor 6, the encoders 12a, 12b and the like are collectively shown by one block.

As shown in FIG. 5, the inverted two-wheel guided vehicle 10 shown in FIG. 1 is a two-input six-output system for outputting six state variables x of equation (6) using the torque command T to the first actuators 3a, 3b for driving the wheels 1a, 1b and the thrust command F to the second actuator 11 of the moving mechanism 7.

Here, out of the state variables x of equation (6) of the inverted two-wheel guided vehicle 10, only the angle of rotation θ of the wheels 1a, 1b and the angle of inclination φ of the vehicle body 4 are respectively detected by the encoders 12a, 12b and the inclination sensor 6. Further, two detection signals indicating the angle of rotation θ and the angle of inclination φ and two input signals indicating the torque command T to the wheels 1a, 1b and the thrust command F to the moving mechanism 7 are inputted to the state observer 42, and the state variables (δ, φ′, θ′, δ′) of equation (6) that cannot be detected using encoders and sensors (hereinafter, [·] indicating the first order temporal differentiation of variables in figures and equations is written by [′] in the specification) are also estimated and the obtained estimated values x̂ of the state variables x (hereinafter, [̂] indicating estimated values above variables in figures and equations is written after the variables in the specification) are inputted to the stabilization compensator 41.

The stabilization compensator 41 outputs stabilization signals P (two output signals Tp, Fp) generated by multiplying the state variables x̂ estimated by the state observer 42 by a state feedback grain for the stabilization of the control system to the drive controller 43. The stabilization signals P can be obtained by equation (9). Here, a feedback gain FG indicates the state feedback gain and is a 2×6 matrix expressed by equation (10).

$$\begin{matrix}P = [ \begin{matrix}Tp \\ Fp\end{matrix} ] = - FG \cdot \hat{x} & ( 9 ) \\ FG = [ \begin{matrix}f 1 & f 2 & f 3 & f 4 & f 5 & f 6 \\ g 1 & g 2 & g 3 & g 4 & g 5 & g 6\end{matrix} ] & ( 10 )\end{matrix}$$

Specifically, the state feedback is controlled and operated by multiplying all the state variables x̂ of the control system by the respective gain coefficients of equation (10) by equation (9). A control method for stabilizing the control system by the state feedback has been conventionally frequently used as an optimal regulator problem, and a method for obtaining the feedback gain FG is known as a solution of a Riccati equation. In this embodiment as well, these known technologies can be used. In this way, the stabilization compensator 41 and the state observer 42 function as an example of the stabilization compensating section for generating the stabilization signals P used to control the posture of the vehicle body 4 by having at least the respective detection signals of the inclination sensor 6 and the encoders 12a, 12b inputted thereto.

The target state generator 44 functions as a target commanding section for generating at least one target command value out of the position and speed of the carriage 5 and, for example, generates a target angle θr of the wheels 1a, 1b and a target angle of inclination φr of the vehicle body 4 from an angular velocity command θr′. In this case, the target angle of inclination φr is zero so as not to incline the vehicle body 4.

The angle of rotation θ of the inverted two-wheel guided vehicle 10 and the angle of inclination of the vehicle body 4 are fed back to the deviation compensator 45, and the deviation compensator 45 outputs deviation compensation signals E (two output signals Te, Fe) to the drive controller 43 after performing suitable operations based on deviations between the target values (θr, φr) outputted by the target state generator 44 and the outputs (θ, φ) of the inverted two-wheel guided vehicle 10 (encoders 12a, 12b and inclination sensor 6).

The drive controller 43 adds the stabilization signals P and the deviation compensation signals E outputted by the stabilization compensator 41 and the deviation compensator 45 to generate the torque command T and the thrust command F of equation (7). In other words, the torque command T and the thrust command F are respectively obtained by equations (11) and (12).

T=Tp+Te (11)

F=Fp+Fe (12)

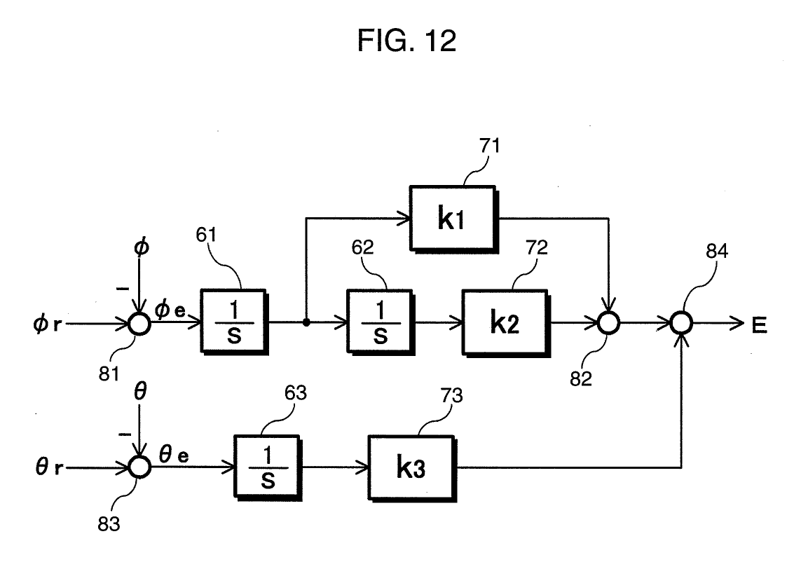

The torque command T and the thrust command F generated by the drive controller 43 are inputted to the inverted two-wheel guided vehicle 10 (first actuators 3a, 3b and second actuator 11), wherein a feedback control is carried out so that a rotational angular velocity θ′ of the wheels 1a, 1b coincides with the angular velocity command θr′ and the angle of inclination φ of the vehicle body 4 coincides with the target angle of inclination φr (=0). It should be noted that the detailed operation of the deviation compensator 45 is described later with reference to FIG. 12.

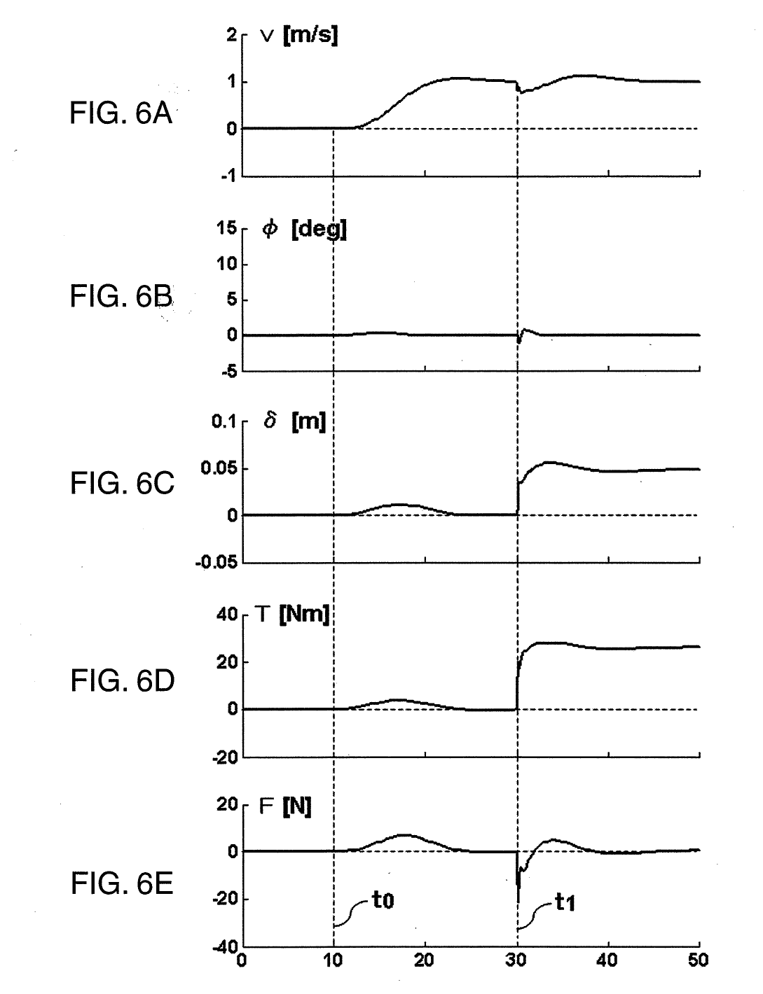

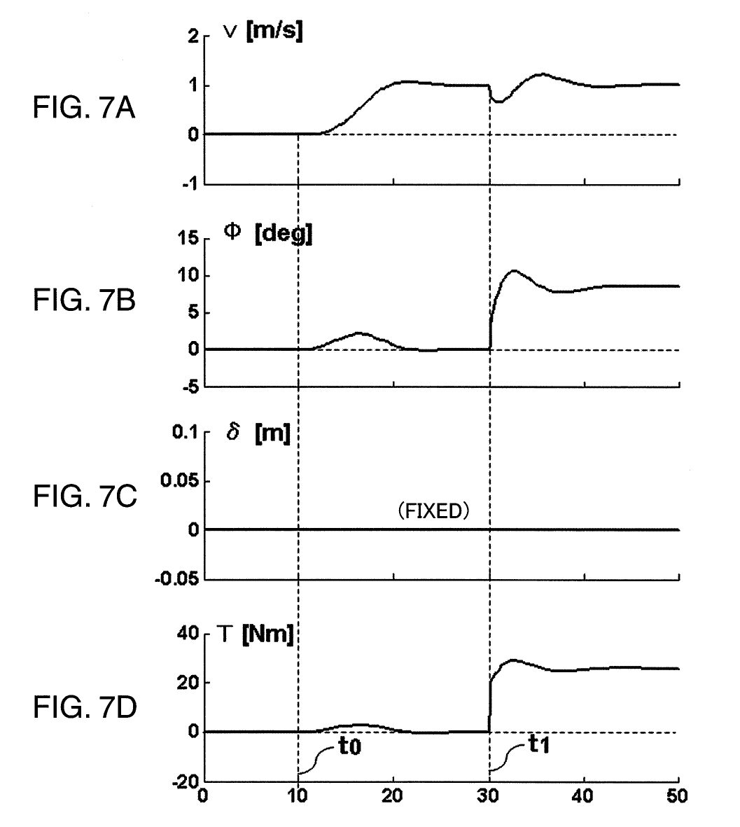

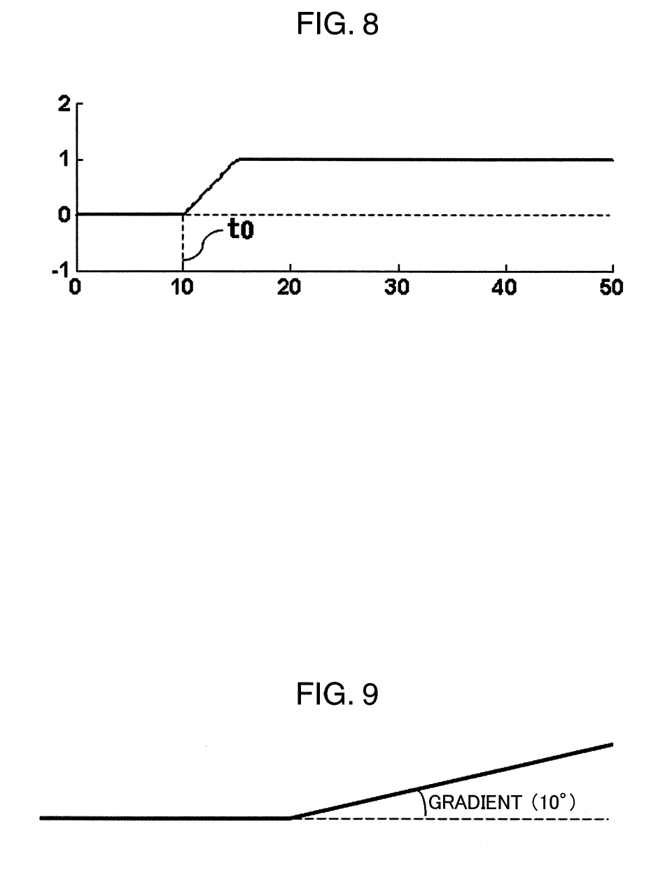

FIG. 6A trough FIG. 6E are time waveform graphs showing a simulation result obtained by combining the control system shown in FIG. 5 and a linear model expressed by equation (8) in the inverted two-wheel guided vehicle 10 including the moving mechanism 7 according to this embodiment, and FIG. 7A trough FIG. 7D are time waveform graphs showing a simulation result of a conventional inverted two-wheel guided vehicle including no moving mechanism for the comparison of the effect of the moving mechanism 7. In FIG. 6A trough FIG. 7D, it is assumed that a speed command is given to the respective inverted two-wheel guided vehicles to accelerate from time t0 and reach a moving speed of 1 m/s and the inverted two-wheel guided vehicles climb up a slope having a gradient of 10° and shown in FIG. 9 from time t1 as shown in FIG. 8.

In FIG. 6A trough FIG. 6E, FIG. 6A shows a moving speed v indicating a state of the inverted two-wheel guided vehicle 10 accelerating from an inverted stationary state (time t0) to 1 m/s, FIG. 6B shows the angle of inclination φ of the vehicle body 4 when the moving mechanism 7 is actuated, FIG. 6C shows the relative displacement amount δ of the moving mechanism 7, FIG. 6D shows a rotational torque T of the wheels 1a, 1b and FIG. 6E shows the thrust F of the second actuator 11 acting on the moving mechanism 7. Here, the moving speed v of the inverted two-wheel guided vehicle 10 is obtained by equation (13), where r denotes the radius of the wheels 1a, 1b and θ′ denotes the rotational angular velocity of the wheels 1a, 1b.

v=r·\dot{θ} (13)

On the other hand, in FIG. 7A trough FIG. 7D, FIG. 7A shows a moving speed v similar to FIG. 6A, FIG. 7B shows the angle of inclination φ of the vehicle body 4 when the moving mechanism is so fixed (δ=0) as not to be displaced, FIG. 7C shows a fixed state (δ=0) of the moving mechanism and FIG. 7D shows the rotational torque T of the wheels 1a, 1b.

Since the moving mechanism 7 acts in this embodiment as shown in FIG. 6A trough FIG. 6E, the relative displacement amount δ of the moving mechanism 7 is about 1 cm in the traveling direction at the time of acceleration from the stationary state t0 and the vehicle body 4 is only slightly inclined forward (φ≈0) in the traveling direction. Also when the inverted two-wheel guided vehicle 10 climbs up the slope of FIG. 8 at time t1, the relative displacement amount δ of the moving mechanism 7 is about 5 cm in the traveling direction, but the vehicle body 4 is not inclined forward.

On the contrary, the conventional inverted two-wheel guided vehicle (equivalent to the inverted two-wheel guided vehicle with the fixed moving mechanism) of FIG. 7A trough FIG. 7D is inclined forward (φ=2°) in the traveling direction at the time of acceleration from the stationary state t0. This forward inclined posture is corrected (φ=0°) when the inverted two-wheel guided vehicle moves at a constant speed thereafter, but the inverted two-wheel guided vehicle is inclined forward (φ=8°) again upon reaching and starting climbing up the slope at time t1.

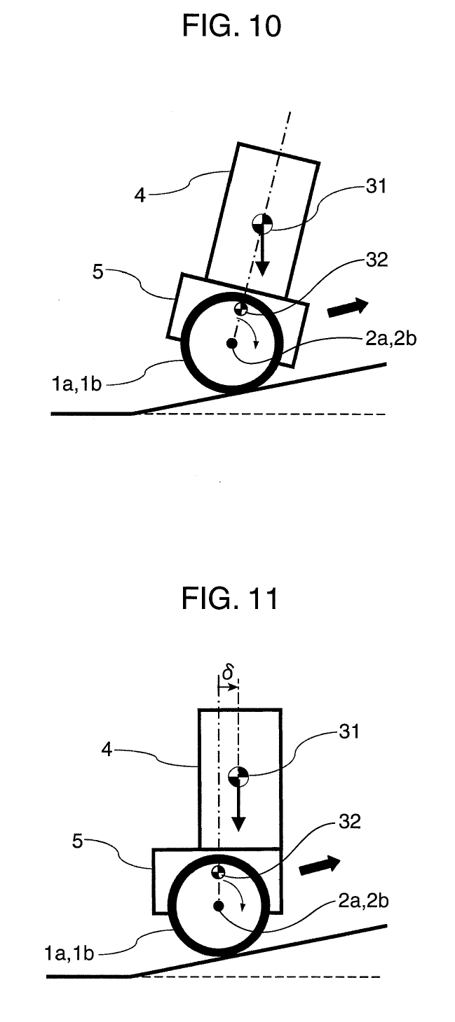

FIGS. 10 and 11 are diagrams showing the forward inclined postures of the vehicle bodies based on the simulation results during uphill operations of the inverted two-wheel guided vehicles of FIG. 7A trough FIG. 7D and FIG. 6A trough FIG. 6E. In FIGS. 10 and 11, corresponding parts are identified by the same reference numerals in order to facilitate the comparison.

FIG. 10 shows the case of the conventional inverted two-wheel guided vehicle having no moving mechanism, wherein the vehicle body 4 is inclined forward and the center of gravity 31 of the vehicle body 4 and that 32 of the carriage 5 move forward in the traveling direction. Thus, rotational moments are generated in the vehicle body 4 and the carriage 5 in a clockwise direction about the axles 2a, 2b by a gravitational force.

Here, since the moving mechanism is fixed (δ=0) in the case of FIG. 10, the following equation (14) holds if it is assumed that φ denotes the angle of inclination of the vehicle body 4 and the carriage 5 and T denotes the rotational torque of the wheels 1a, 1b (since there are two wheels 1a, 1b, T is shown to be double the torque generated by one wheel). It should be noted that g denotes gravitational acceleration acting on the masses m1, m2 and the respective constants and variables are written similar to this embodiment.

T=(m1·l1+m2·l2)·g·sin φ (14)

Specifically, in the conventional inverted two-wheel guided vehicle having no moving mechanism, the rotational torque T cannot be generated in the wheels 1a, 1b unless this inverted two-wheel guided vehicle is inclined forward and, hence, the uphill operation cannot be performed with the rotational torque and the rotational moment by the gravitational force held in equilibrium as shown in equation (14). This tendency is in proportion to the magnitude of the gradient. If the gradient of the slope of FIG. 9 increases, the rotational torque T necessary for the uphill operation increases and the angle of inclination φ of the vehicle body 4 also increases from equation (14).

On the other hand, FIG. 11 shows the case of the inverted two-wheel guided vehicle having the moving mechanism 7 according to this embodiment, wherein the center of gravity 31 of the vehicle body 4 moves forward only by the relative displacement amount δ in the traveling direction by the action of the moving mechanism 7. If it is assumed that the center of gravity 32 of the carriage 5 is located above the axles 2a, 2b, the rotational moment by the gravitational force is not generated in the carriage 5. In this way, the center of gravity 31 of the vehicle body 4 moves forward only by the relative displacement amount δ in the traveling direction by the action of the moving mechanism 7, whereby a rotational moment is generated in the vehicle body 4 in the clockwise direction about the axles 2a, 2b by the gravitational force. If it is assumed that δ denotes the relative displacement amount of the moving mechanism 7 and T denotes the torque generated by the wheels, the following equation (15) holds.

T=m1·g·δ (15)

As described above, the term of the angle of inclination φ of the vehicle body 4 as seen in equation (14) is not included in equation (15). In other words, since the center of gravity of the vehicle body 4 can be moved in the traveling direction by the action of the moving mechanism 7 in the inverted two-wheel guided vehicle 10 of this embodiment, the center of gravity position of the vehicle body 4 can be automatically moved even if the inverted two-wheel guided vehicle is not inclined forward like the conventional inverted two-wheel guided vehicle and the uphill operation can be performed while the loading platform loaded with baggage or a person, i.e. the seat 8 is constantly horizontally held.

Although the uphill operation is simulated in the above description, the inverted two-wheel guided vehicle 10 of this embodiment can constantly horizontally hold the seat 8 not only during the uphill operation, but also during a downhill operation by the action of the moving mechanism 7.

Next, the operation of the deviation compensator 45 is described in detail. As shown in FIG. 5, the angle of rotation θ of the wheels 1a, 1b and the angle of inclination φ of the vehicle body 4 are fed back from the inverted two-wheel guided vehicle 10 (encoders 12a, 12b and inclination sensor 6) to the deviation compensator 45, and the deviation compensator 45 calculates deviations (θe, φe) between the target values (θr, φr) outputted by the target state generator 44 and the outputs (θ, φ) of the inverted two-wheel guided vehicle 10 (first actuators 3a, 3b and second actuator 11). Subsequently, the deviation compensator 45 outputs the deviation compensation signals E (two output signals Te, Fe) to the drive controller 43 after performing suitable operations based on the deviations (θe, φe).

FIG. 12 is a block diagram showing an example of the deviation compensator 45 used in the control system of the inverted two-wheel guided vehicle 10 according to the first embodiment shown in FIG. 5. In FIG. 12, s denotes a Laplace operator and k1, k2 and k3 denote gain coefficients and are respectively two-dimensional vectors.

In FIG. 12, the deviation compensator 45 includes a first integrator 61, a second integrator 62, a third integrator 63, a first multiplier 71, a second multiplier 72, a third multiplier 73, a first comparator 81, a signal adder 82, a second comparator 83 and a signal adder 84.

The first comparator 81 compares the target angle of inclination φr (φr=0 in this case) and the angle of inclination φ of the vehicle body 4 and outputs an angle of inclination deviation φe (=φr−φ) to the first integrator 61. The first integrator 61 applies time integration to the angle of inclination deviation φe and outputs the obtained integrated output respectively to the second integrator 62 and the first multiplier 71. The second integrator 62 further integrates the integrated output of the first integrator 61 and outputs a doubly integrated signal to the second multiplier 72. By connecting the first and second integrators 61, 62 in series in this way, double integration is performed.

Subsequently, the first multiplier 71 multiplies the inputted integrated output of the first integrator 61 by the first coefficient k1 and outputs the resultant to the signal adder 82. The second multiplier 72 multiplies the doubly integrated signal of the second integrator 62 by the second coefficient k2 and outputs the resultant to the signal adder 82. The signal adder 82 adds the output of the first multiplier 71 and that of the second multiplier 72, and outputs the obtained processed signal of the angle of inclination deviation be to a signal synthesizer 84. A part made up of the first integrator 61, the second integrator 62, the first multiplier 71, the second multiplier 72 and the signal adder 82 in this way is a block diagram where the angle of inclination deviation φe is processed in the deviation compensator 45.

Further, the second comparator 83 compares the target angle θr of the wheels 1a, 1b and the angle of rotation θ of the wheels 1a, 1b and outputs the angle of rotation deviation θe (θr−θ) to the third integrator 63. The third integrator 63 applies time integration to the angle of rotation deviation θe and outputs the obtained integrated output to the third multiplier 73. The third multiplier 73 multiplies the inputted integrated output of the third integrator 63 by the third coefficient k3 and outputs the obtained processed signal of the angle of rotation deviation θe to the signal synthesizer 84. A part made up of the third integrator 63 and the third multiplier 73 is a block diagram where the angle of rotation deviation θe is processed in the deviation compensator 45. The signal synthesizer 84 adds the processed signal of the angle of inclination deviation φe and that of the angle of rotation deviation θe and outputs a deviation compensation signal E to the drive controller 43.

In the block diagram of FIG. 12, a transfer function relating to the angle of inclination deviation φe is shown by equation (16).

$$Gd ( s ) = \frac{k 1}{s} + \frac{k 2}{{s}^{2}} = \frac{k 1 \cdot s + k 2}{{s}^{2}} \qquad ( 16 )$$

From equation (16), the transfer function Gd relating to the angle of inclination deviation φe of the deviation compensator 45 is expressed in the form of double integration with the order of an s-term in a denominator set to 2. It is important for the transfer function Gd of the deviation compensator 45 that the order of the s-term in the denominator is 2.

In the block diagram of FIG. 12, a transfer function relating the angle of rotation deviation θe is shown in equation (17).

$$Gc ( s ) = \frac{k 3}{s} \qquad ( 17 )$$

The deviation compensation signal E outputted by the signal synthesizer 84 using the above equations (16) and (17) can be expressed by equation (18).

$$E = [ \begin{matrix}Te \\ Fe\end{matrix} ] = Gd ( s ) \cdot φ e + Gc ( s ) \cdot θ e \qquad ( 18 )$$

Here, for the comparison with an operation when the order of the s-term in the denominator of the transfer function Gd of the deviation compensator 45 differs, a simulation result is described for the operation of the inverted two-wheel guided vehicle 10 when the order of the s-term in the denominator is chosen to be 1 in the transfer function Gd of the deviation compensator 45.

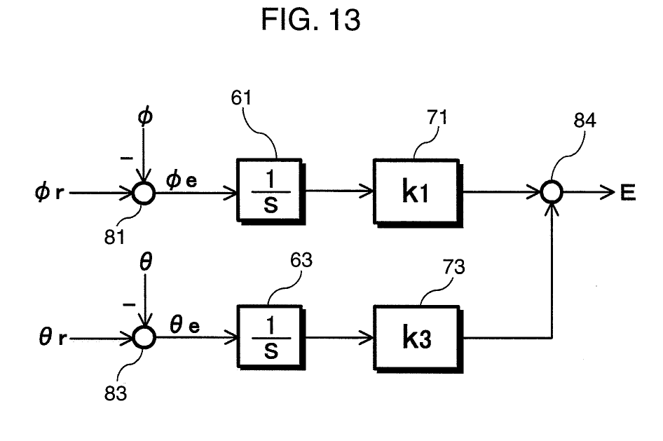

FIG. 13 is a block diagram of a deviation compensator as a comparative example used in the simulation. FIG. 13 is equivalent to the block diagram of FIG. 12 when the gain coefficient k2 is zero. The transfer function relating to the angle of inclination deviation φe in the block diagram of FIG. 13 is expressed in equation (19). As is clear from equation (19), the order of the s-term in the denominator of the transfer function Gd of the deviation compensator of the comparative example is 1.

$$Gd ( s ) = \frac{k 1}{s} \qquad ( 19 )$$

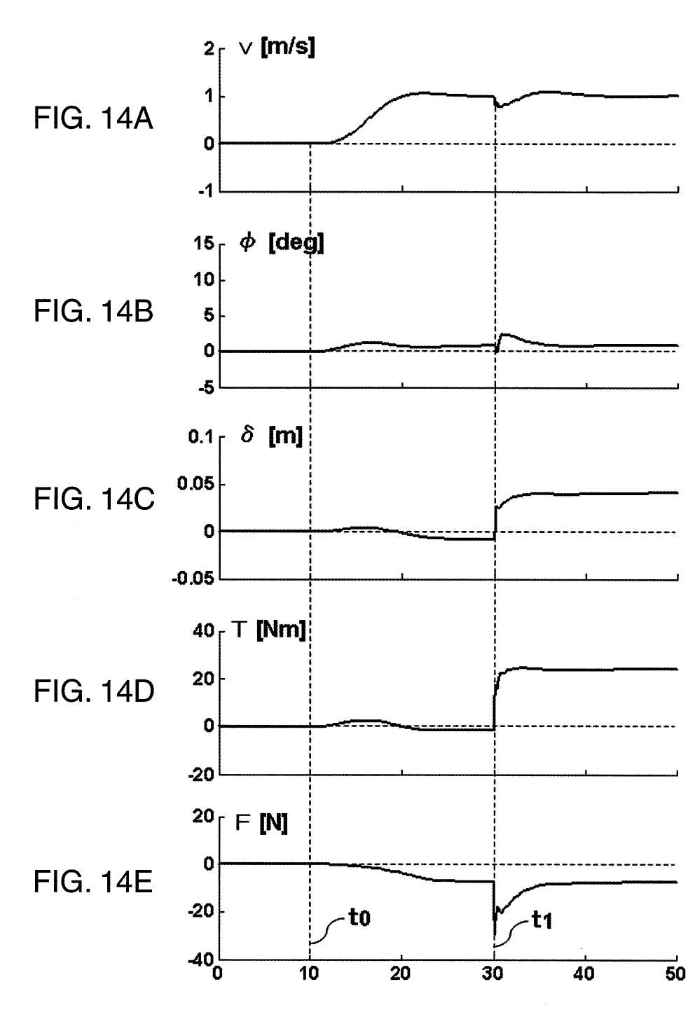

FIG. 14A trough FIG. 14E are time waveform graphs showing a simulation result when the deviation compensator shown in FIG. 13 of the comparative example is used as the construction of the deviation compensator included in the control system of the inverted two-wheel guided vehicle shown in FIG. 5 and the transfer function is expressed by equation (19). On the other hand, a simulation result when the deviation compensator of this embodiment shown in FIG. 12 is used as the construction of the deviation compensator 45 included in the control system shown in FIG. 5 and the transfer function is expressed by equation (16) is shown in the time waveform graphs of FIG. 6A trough FIG. 6E described above.

The simulation result of FIG. 14A trough FIG. 14E differs from that of FIG. 6A trough FIG. 6E only because of a difference in the construction of the deviation compensator 45 included in the control system shown in FIG. 5, and the other respective constants of the inverted two-wheel guided vehicles are the same and the inverted two-wheel guided vehicle of the comparative example is assumed to climb up the slope having an angle of inclination of 10° and shown in FIG. 9 in response to the speed command of FIG. 8. Since FIGS. 14A, 14B, 14C, 14D and 14E respectively correspond to FIGS. 6A, 6B, 6C, 6D and 6E, repeated description is omitted.

In FIG. 14B, when the inverted two-wheel guided vehicle of the comparative example climbs up the slope of FIG. 9, the vehicle body 4 is inclined forward (φ=1.5°). In FIG. 14A trough FIG. 14E, a front part of the moving mechanism 7 arranged between the vehicle body 4 and the carriage 5 in the traveling direction is moved downward since the vehicle body 4 is inclined forward and the vehicle body 4 receives a down sliding force of the moving mechanism 7 in the traveling direction by the action of the gravitational force. As a result, in order to prevent a displacement of the vehicle body 4, the second actuator 11 generates a thrust F in a direction opposite to the traveling direction as shown in FIG. 14E so that the vehicle body 4 counterbalances with the down sliding force in the traveling direction by the gravitational force. In other words, in the case of FIG. 14A trough FIG. 14E, the second actuator 11 needs to constantly generate the thrust F in the direction opposite to the traveling direction during the uphill operation.

On the other hand, if the order of the s-term in the denominator in the transfer function Gd of the deviation compensator 45 is 2 or larger as in this embodiment, the vehicle body 4 is not inclined forward (φ=0°) as shown in FIG. 6B and the second actuator 11 needs not generate the thrust F during the uphill operation when the inverted two-wheel guided vehicle climbs up the slope of FIG. 9. Thus, this inverted two-wheel guided vehicle is more advantageous than the comparative example of FIG. 14A trough FIG. 14E in terms of power consumption.

As described above, the vehicle body 4 is not inclined forward and the moving mechanism 7 is horizontally held both during the uphill operation and during the downhill operation by setting the order of the s-term in the denominator of the deviation compensator 45 included in the control system shown in FIG. 5 to second order or more. Thus, the second actuator 11 needs not constantly generate the thrust F against the gravitational force acting on the vehicle body 4 to maintain the displacement and the seat 8 as the loading platform for baggage or a person can be moved while being constantly horizontally held. As a result, no discomfort is given to the person, lateral sliding of baggage or collapse of baggage piles can be prevented, and power consumption for the driving can be reduced.

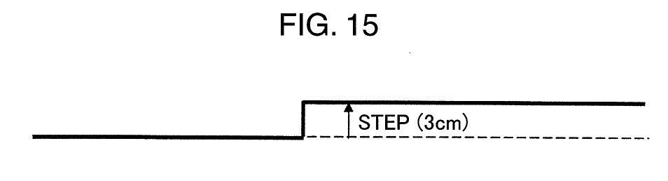

Next, an operation of the inverted two-wheel guided vehicle 10 of this embodiment upon passing a step present in a travel path as shown in FIG. 15 instead of climbing up the slope having a gradient of 10° and shown in FIG. 9 is described. The inverted two-wheel guided vehicle 10 is assumed to pass a step having a height of 3 cm at time t2 to be described later while moving along a travel path at a moving speed v of 0.5 m/s. Using the inverted two-wheel guided vehicle 10 of this embodiment including the moving mechanism 7, simulation is conducted by combining the control system shown in FIG. 5 and the linear model expressed by equation (8).

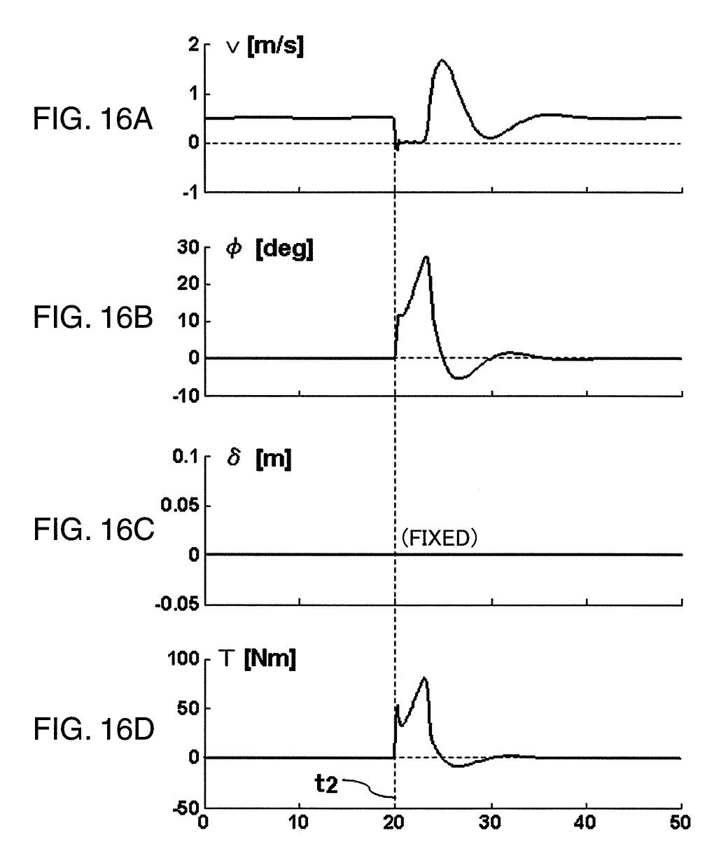

FIG. 16A trough FIG. 16D are time waveform graphs showing a simulation result of the conventional inverted two-wheel guided vehicle including no moving mechanism, i.e. time waveform graphs showing a simulation result of the comparative example in which the moving mechanism 7 of the inverted two-wheel guided vehicle 10 is so fixed (δ=0) as not to be displaced for the comparison of the effect of the moving mechanism 7 of this embodiment. In FIG. 16A trough FIG. 16D, FIG. 16A shows a moving speed v, FIG. 16B shows the angle of inclination φ of the vehicle body 4 when the moving mechanism 7 is fixed, FIG. 16C shows the fixed state (δ=0) of the moving mechanism 7 and FIG. 16D shows the rotational torque T of the wheels 1a, 1b.

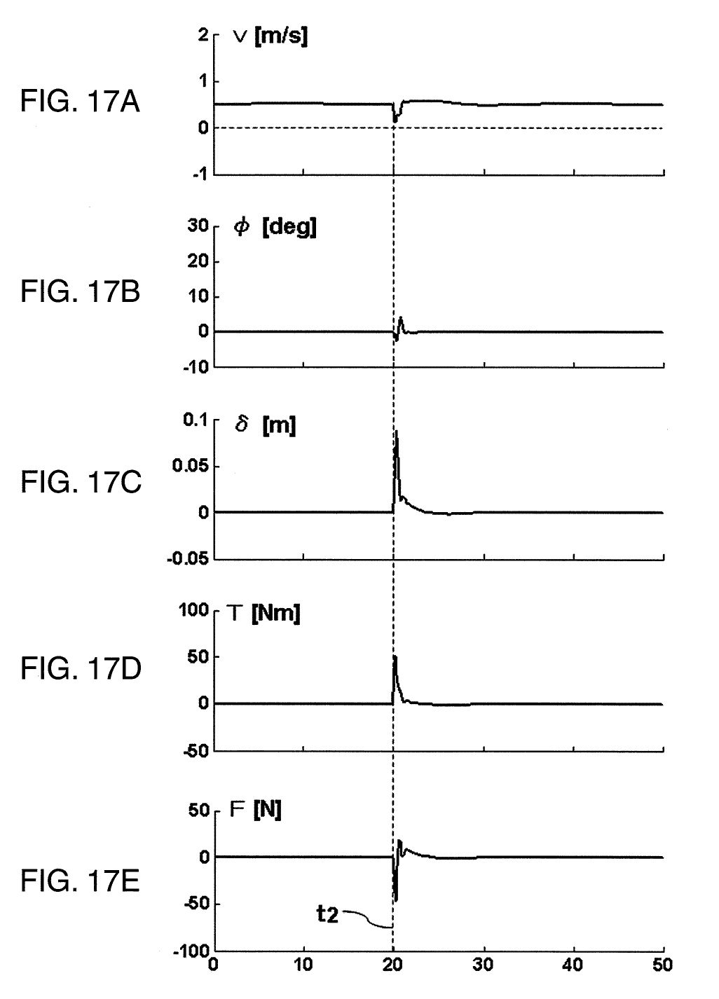

On the other hand, FIG. 17A trough FIG. 17E are time waveform graphs showing a simulation result when the moving mechanism 7 is actuated in the inverted two-wheel guided vehicle 10 of this embodiment. In FIG. 17A trough FIG. 17E, FIG. 17A shows a moving speed v similar to FIG. 16A, FIG. 17B shows the angle of inclination φ of the vehicle body 4 when the moving mechanism 7 is actuated, FIG. 17C shows the relative displacement amount δ of the moving mechanism 7, FIG. 17D shows the rotational torque T of the wheels 1a, 1b and FIG. 17E shows the thrust F of the second actuator 11 acting on the moving mechanism 7.

In FIG. 16A trough FIG. 16D, in the comparative example in which the moving mechanism 7 is so fixed (δ=0) as not to be displaced, the inverted two-wheel guided vehicle cannot move over the step at the position of the step of FIG. 15 at time t2 and temporarily stops as shown in FIG. 16A. In the simulation result of FIG. 16A trough FIG. 16D, the vehicle body 4 is gradually inclined forward in the traveling direction with time as shown in FIG. 16B, and the rotational torque T of the wheels 1a, 1b increases with time as shown in FIG. 16D. The inverted two-wheel guided vehicle finally moves over the step when the angle of inclination φ of the vehicle body 4 reaches 30°.

In the above simulation and an actual control, the linear model of equation (8) was used, assuming that equations (4) and (5) hold. However, if the angle of inclination φ of the vehicle body 4 is equal to or larger than 10°, the linear model of equation (8) cannot be adopted and the inverted two-wheel guided vehicle 10 cannot be accurately controlled. Accordingly, the inverted two-wheel guided vehicle of the comparative example is thought to be unable to move over the step of FIG. 15 when the moving mechanism 7 is so fixed (δ=0) as not to be displaced.

In contrast, if the moving mechanism 7 is actuated in the inverted two-wheel guided vehicle 10 of this embodiment as shown in FIG. 17A trough FIG. 17E, the relative displacement amount δ of the moving mechanism 7 in the traveling direction is about 9 cm when the inverted two-wheel guided vehicle 10 passes the step of FIG. 15 at time t2, but the angle of inclination φ of the vehicle body 4 is very small. Accordingly, the control is accurately executed using the linear model of equation (8) and the inverted two-wheel guided vehicle 10 of this embodiment can move over the step of FIG. 15 without any problem.

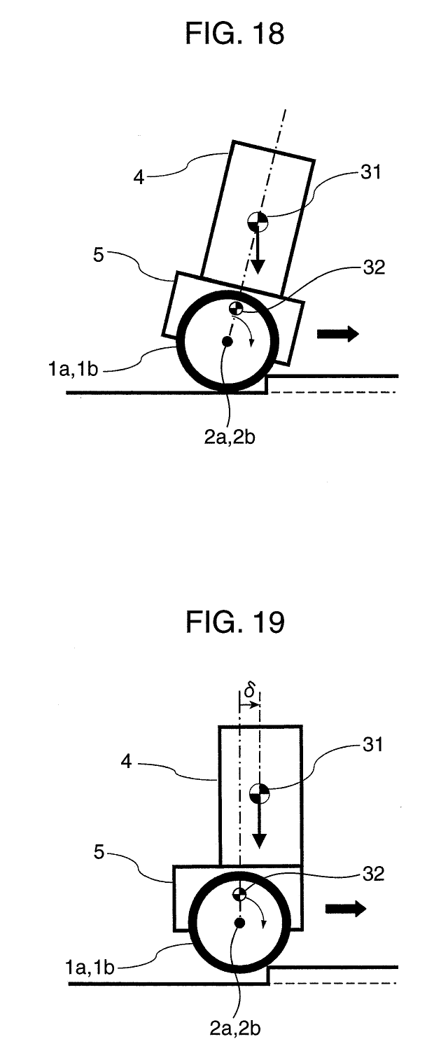

FIGS. 18 and 19 are views diagrammatically showing the forward inclined postures of the vehicle bodies 4 based on the simulation results shown in FIG. 16A trough FIG. 17E when the inverted two-wheel guided vehicles pass the step. In FIGS. 18 and 19, corresponding parts are identified by the same reference numerals to facilitate the comparison.

FIG. 18 shows the case of the conventional inverted two-wheel guided vehicle including no moving mechanism, wherein the vehicle body 4 stops and is inclined forward at the position of the step and the center of gravity 31 of the vehicle body 4 and that 32 of the carriage 5 move forward in the traveling direction. Thus, rotational moments are generated in the vehicle body 4 and the carriage 5 in the clockwise direction about the axles 2a, 2b by the gravitational force. At this time, the wheels 1a, 1b generate the rotational torque T in such a manner as to satisfy equation (14) for the angle of inclination φ of the vehicle body 4. However, the rotational torque T sufficient to move over the step cannot be generated in a range where the control system holds the linear model of equation (8) and the inverted two-wheel guided vehicle cannot move over the step.

On the other hand, FIG. 19 shows the case of the inverted two-wheel guided vehicle of this embodiment including the moving mechanism 7, wherein the center of gravity 31 of the vehicle body 4 is moved forward in the traveling direction by the relative displacement amount 6 by the action of the moving mechanism 7. Even if the vehicle body 4 is moved forward in the traveling direction by the relative displacement amount 6, it is not inclined forward and the angle of inclination φ is small. Thus, the control system constantly holds the linear model of equation (8). Since the center of gravity of the vehicle body 4 is moved forward in the traveling direction by the relative displacement amount δ by the action of the moving mechanism 7, the vehicle body 4 generates the rotational moment in the clockwise direction about the axles 2a, 2b by the gravitational force. Since the wheels 1a, 1b generate the rotational torque T in such a manner as to satisfy equation (15) in response to the relative displacement amount δ of the vehicle body 4, the step can be moved over provided that the rotational torque T necessary to move over the step can be generated in a movable range of the moving mechanism 7.

As is clear from the above description, by letting the moving mechanism 7 to act as shown in FIG. 19, it is possible to move the center of gravity position of the entire vehicle body 4 loaded with baggage or a person forward in the traveling direction even upon the step moving-over operation, which has been difficult with the conventional inverted two-wheel guided vehicle. Therefore, there is an effect of being able to move over the step in a stable posture.

### Second Embodiment

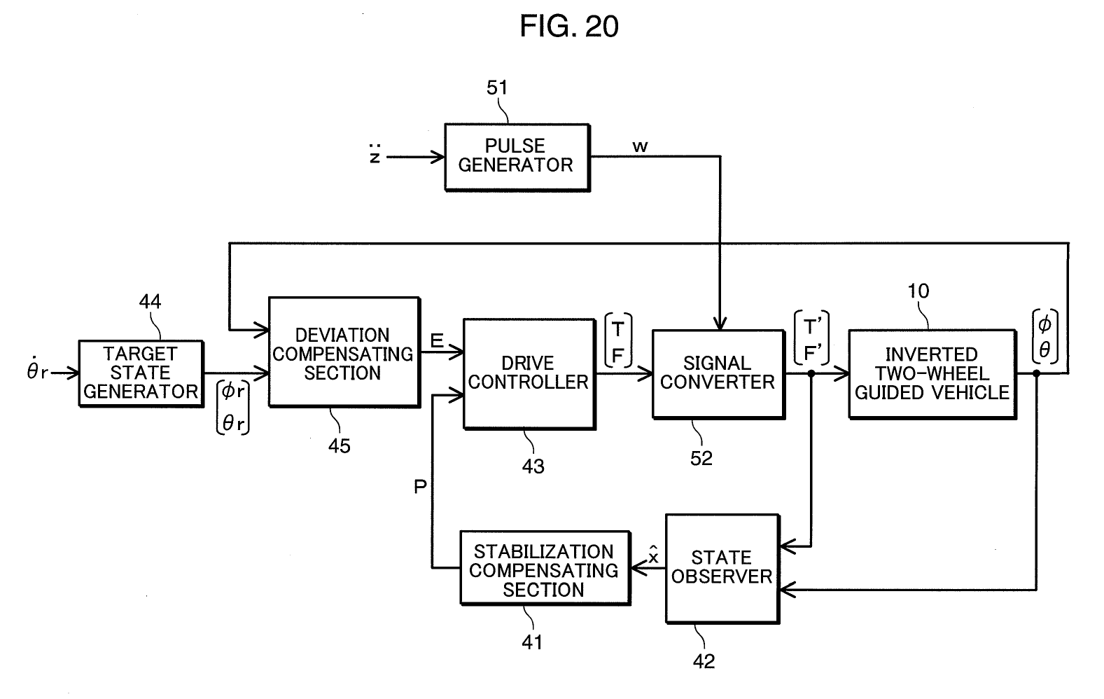

FIG. 20 is a block diagram showing an example of a controller of an inverted two-wheel guided vehicle according to a second embodiment of the present invention. In FIG. 20, the same constituent elements as in FIG. 5 are identified by the same reference numerals and not repeatedly described. The entire construction of this embodiment is similar to that of the first embodiment shown in FIGS. 1 to 4 except for the controller shown in FIG. 20 and, hence, not shown. The respective parts are described using the same reference numerals as in the first embodiment.

In this embodiment, the vertical acceleration sensor 13 shown in FIG. 2 is used and the inverted two-wheel guided vehicle 10 executes a control for a vertical displacement such as the one caused by a step present in a travel path. In other words, the vertical acceleration sensor 13 constituting the vertical acceleration detector is mounted in the inverted two-wheel guided vehicle 10. For example, when the inverted two-wheel guided vehicle 10 moves onto a step or the like present in the travel path, the vertical acceleration sensor 13 detects the vertical acceleration of the carriage 5 and outputs an acceleration signal z″ (hereinafter, [··] indicating second order temporal differentiation above variables in figures and equations is written by [″] in the specification).

In FIG. 20, the acceleration signal z″ is inputted to a pulse generator 51, and the pulse generator 51 measures the magnitude of the inputted acceleration signal z″ and outputs a pulse signal w to a signal converter 52 when a change of vertical acceleration exceeds a specified value. A torque command T and a thrust command F generated by the drive controller 43 of FIG. 5 are inputted to the signal converter 52, and the signal converter 52 outputs converted torque command T′ and converted thrust command F′ to the inverted two-wheel guided vehicle 10 (first actuators 3a, 3b and second actuator 11) in accordance with the pulse signal w.

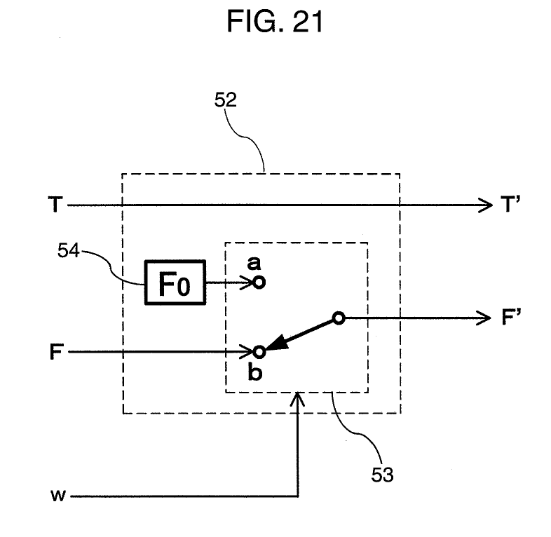

FIG. 21 is a block diagram showing a more specific example of the signal converter 52 constituting the controller shown in FIG. 20. In FIG. 21, the torque command T inputted from the drive controller 43 is directly outputted as the converted torque command T′ to the inverted two-wheel guided vehicle 10 (first actuators 3a, 3b). The thrust command F inputted from the drive controller 43 is outputted as the converted thrust command F′ to the inverted two-wheel guided vehicle 10 (second actuator 11) via a changeover switch 53.

An output terminal of the changeover switch 53 is connected with a terminal “a” or a terminal “b” depending on the pulse signal w outputted from the pulse generator 51. If the pulse generator 51 outputs the pulse signal w to the changeover switch 53 constituting the signal converter 52, the changeover switch 53 is switched to the terminal “a” and the thrust command F inputted from the drive controller 43 is not outputted to the inverted two-wheel guided vehicle 10 and a constant value FO generated by a signal generator 54 constituting the signal converter 52 is outputted as the converted thrust command F′.

On the other hand, if the pulse signal w is not outputted to the changeover switch 53, the output terminal of the changeover switch 53 is connected with the terminal “b” and the thrust command F inputted from the drive controller 43 is directly outputted as the converted thrust command F′ to the inverted two-wheel guided vehicle 10 (second actuator 11).

Specifically, when the inverted two-wheel guided vehicle 10 passes a step present in the travel path by moving over it, the vertical acceleration sensor 13 detects vertical acceleration and the signal converter 52 converts the thrust command F and outputs the converted thrust command F′ to the inverted two-wheel guided vehicle 10. In this way, the controller 9 constituting the control system of the inverted two-wheel guided vehicle according to this embodiment controls a vertical displacement such as the one caused by a step present in the travel path.

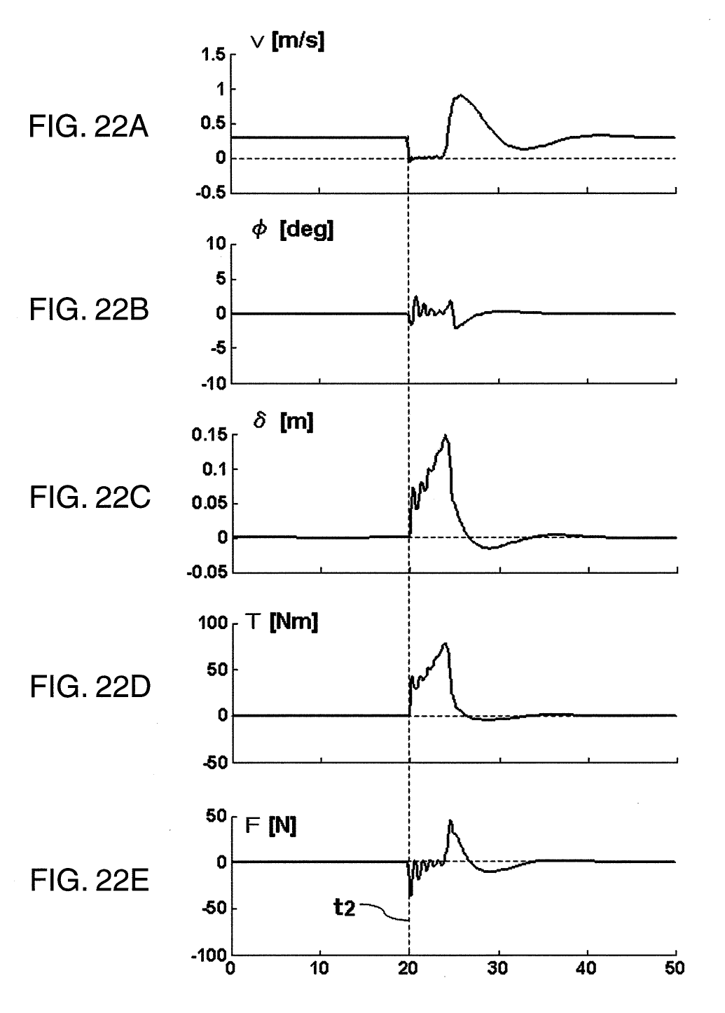

FIG. 22A trough FIG. 22E are time waveform graphs showing a simulation result on a step moving-over operation in the case where the inverted two-wheel guided vehicle 10 including the moving mechanism 7 is not provided with the vertical acceleration sensor as a comparative example. It is assumed that a step having a height of 3 cm as shown in FIG. 15 is present in a travel path used in this simulation and the inverted two-wheel guided vehicle 10 of the comparative example moves over this step.

The simulation of FIG. 22A trough FIG. 22E differs from that of FIG. 17A trough FIG. 17E in that the inverted two-wheel guided vehicle 10 passes the step at the moving speed v of 0.5 m/s in FIG. 17A trough FIG. 17E, but the inverted two-wheel guided vehicle 10 passes the step at the moving speed v of 0.3 m/s in FIG. 22A trough FIG. 22E. Generally, the higher the moving speed v of the inverted two-wheel guided vehicle 10, the larger the kinetic energy of the inverted two-wheel guided vehicle 10. The higher the moving speed v, the more easily the inverted two-wheel guided vehicle 10 can move over the step. On the other hand, if the moving speed v of the inverted two-wheel guided vehicle is slowed, it is expected to be more difficult to move over the step.

In FIG. 22A trough FIG. 22E, FIG. 22A shows the moving speed v, FIG. 22B shows the angle of inclination φ of the vehicle body 4, FIG. 22C shows the relative displacement amount δ of the moving mechanism 7, FIG. 22D shows the rotational torque T of the wheels 1a, 1b and FIG. 22E shows the thrust F of the second actuator 11 acting on the moving mechanism 7.

As shown in FIG. 17A trough FIG. 17E, the inverted two-wheel guided vehicle 10 could move over the step of FIG. 15 without any problem when the moving speed v was 0.5 m/s. However, in the case of reducing the moving speed v to 0.3 m/s, the inverted two-wheel guided vehicle 10 temporarily stops at the step at time t2 as shown in FIG. 22A. At this time, the relative displacement amount δ of the moving mechanism 7 gradually increases in the traveling direction with time as shown in FIG. 22C.

The rotational torque T of the wheels 1a, 1b increases while satisfying equation (15) as shown in FIG. 22D, and the inverted two-wheel guided vehicle 10 moves over the step when the relative displacement amount δ of the moving mechanism 7 substantially reaches 15 cm. Since the posture of the vehicle body 4 is controlled by the controller 9, the angle of inclination φ of the vehicle body 4 varies in forward and backward directions within a very small range as shown in FIG. 22B and the inverted two-wheel guided vehicle is not largely inclined forward.

As described above, since the inverted two-wheel guided vehicle 10 temporarily stops at the position of the step, a time required to move over the step is about 5 sec. Since the inverted two-wheel guided vehicle 10 temporarily stops at the position of the step in this way, the kinetic energy of the moving speed v does not effectively act for the step moving-over operation. As a result, in the inverted two-wheel guided vehicle 10 including no vertical acceleration sensor, the rotational torque T of the wheels 1a, 1b necessary to move over the step becomes 80 Nm as shown in FIG. 22D, wherefore a large torque is necessary.

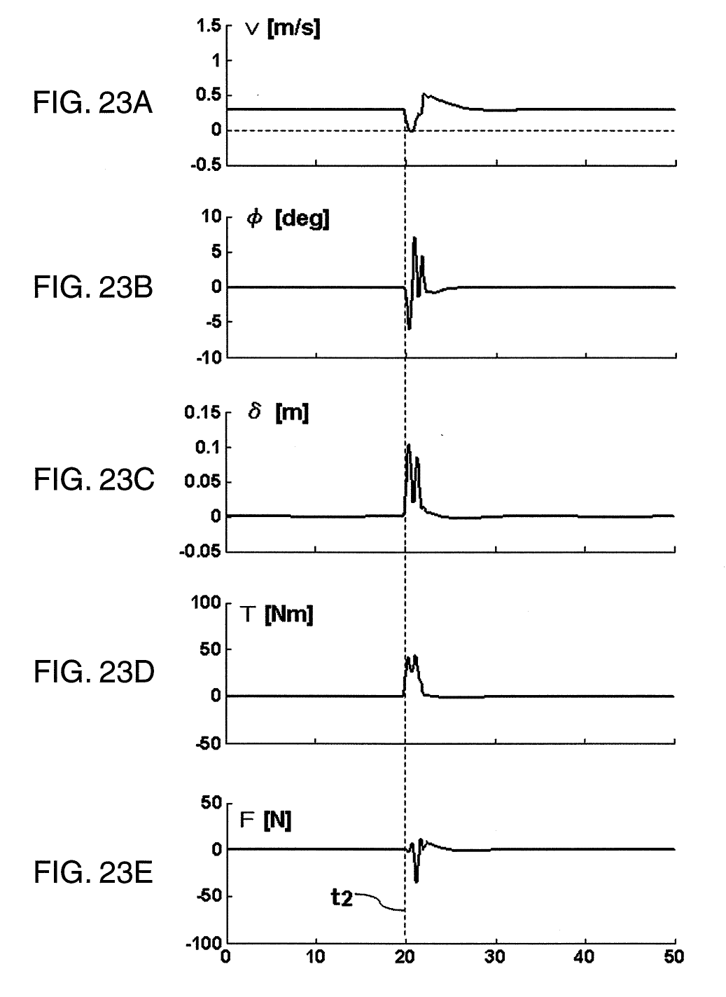

FIG. 23A trough FIG. 23E are time waveform graphs showing a simulation result on a step moving-over operation of the inverted two-wheel guided vehicle 10 including the vertical acceleration sensor 13 according to this embodiment. It is assumed that a step having a height of 3 cm as shown in FIG. 15 is present in a travel path used in this simulation similar to FIG. 22A trough FIG. 23E and the inverted two-wheel guided vehicle 10 passes the step at the moving speed v of 0.3 m/s. At this time, the inverted two-wheel guided vehicle 10 of this embodiment includes the vertical acceleration sensor 13 constituting the vertical acceleration detector and executes a control for a vertical displacement such as the one caused by the step present in the travel path.

In FIG. 23A trough FIG. 23E, FIG. 23A shows a moving speed v similar to FIG. 22A, FIG. 23B shows the angle of inclination φ of the vehicle body 4 when a vertical displacement was controlled using the vertical acceleration sensor 13 and the controller shown in FIG. 20, FIG. 23C shows the relative displacement amount δ of the moving mechanism 7, FIG. 23D shows the rotational torque T of the wheels 1a, 1b and FIG. 23E shows the thrust F of the second actuator 11 acting on the moving mechanism 7.

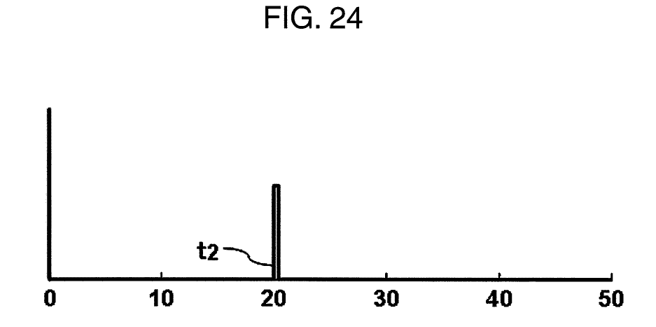

As shown in FIG. 23A trough FIG. 23E, when the inverted two-wheel guided vehicle 10 reaches the step shown in FIG. 15 at time t2 and the vertical acceleration sensor 13 detects the vertical acceleration, the pulse generator 51 outputs a pulse signal was shown in FIG. 24 to the signal converter 52. The pulse width of the pulse signal w of FIG. 24 is assumed to be, for example, 0.5 sec.

The pulse signal w inputted to the signal converter 52 causes the changeover switch 53 to be switched to the terminal “a”, the thrust command F inputted from the drive controller 43 is shut off from the control system and the constant value FO generated by the signal generator 54 constituting the signal converter 52 is outputted as the converted thrust command F′. Since the constant value FO generated by the signal generator 54 is chosen to be zero (FO=0) in the example of FIG. 23A trough FIG. 23E, the thrust F of the second actuator 11 acting on the moving mechanism 7 is zero as shown in FIG. 23E for a period during which the pulse signal w is inputted to the signal converter 52.

Even if the thrust F of the second actuator 11 is zero when the inverted two-wheel guided vehicle 10 reaches the step shown in FIG. 15 at time t2, the vehicle body 4 is displaced only by about 10 cm as the relative displacement amount δ in the traveling direction due to an inertial force as shown in FIG. 23C. Since the vehicle body 4 is largely displaced in the traveling direction in this way, it tries to make a forward inclining movement in the traveling direction.

On the other hand, since the rotational torque T of the wheels 1a, 1b constitutes the control system even during the step moving-over operation at time t2, the posture of the vehicle body 4 is controlled and the rotational torque T is increased in such a direction as to move over the step as shown in FIG. 23D so that the vehicle body 4 is not inclined forward. By the reaction of this rotational torque T, the vehicle body 4 is inclined in a direction opposite to the traveling direction as shown in FIG. 23B, but the angle of inclination φ is suppressed to −5°. As a result, the inverted two-wheel guided vehicle 10 momentarily stops at the position of the step in the case of FIG. 23A trough FIG. 23E, but can more smoothly move over the step as compared with the case of FIG. 22A trough FIG. 22E.

As described above, in this embodiment, the vertical acceleration sensor 13 detects the vertical acceleration, whereby the step arriving timing of the inverted two-wheel guided vehicle 10 is detected and the pulse signal w is outputted to the changeover switch 53. At this timing, the thrust F of the second actuator 11 is set to zero (case where the constant value FO generated by the signal generator 54 is set to zero) to displace the vehicle body 4 in the running directing by the inertial force and the rotational torque T of the wheels 1a, 1b is increased for the step moving-over operation. Thus, the kinetic energy of the moving speed v effectively acts for the step moving-over operation and the rotational torque T of the wheels 1a, 1b necessary for this operation is sufficient to be a torque smaller than the one shown in FIG. 22D.

As is clear from the above description, by providing the vertical acceleration sensor 13 for detecting the vertical acceleration of the carriage 5 and executing a control for a vertical displacement such as the one caused by a step present in a travel path, the inverted two-wheel guided vehicle of the second embodiment can move the center of gravity position of the entire vehicle body 4 loaded with baggage or a person forward upon a step moving-over operation which has been difficult to perform by the conventional inverted two-wheel guided vehicle. Therefore, there is an effect of being able to more smoothly move over the step in a stable posture.

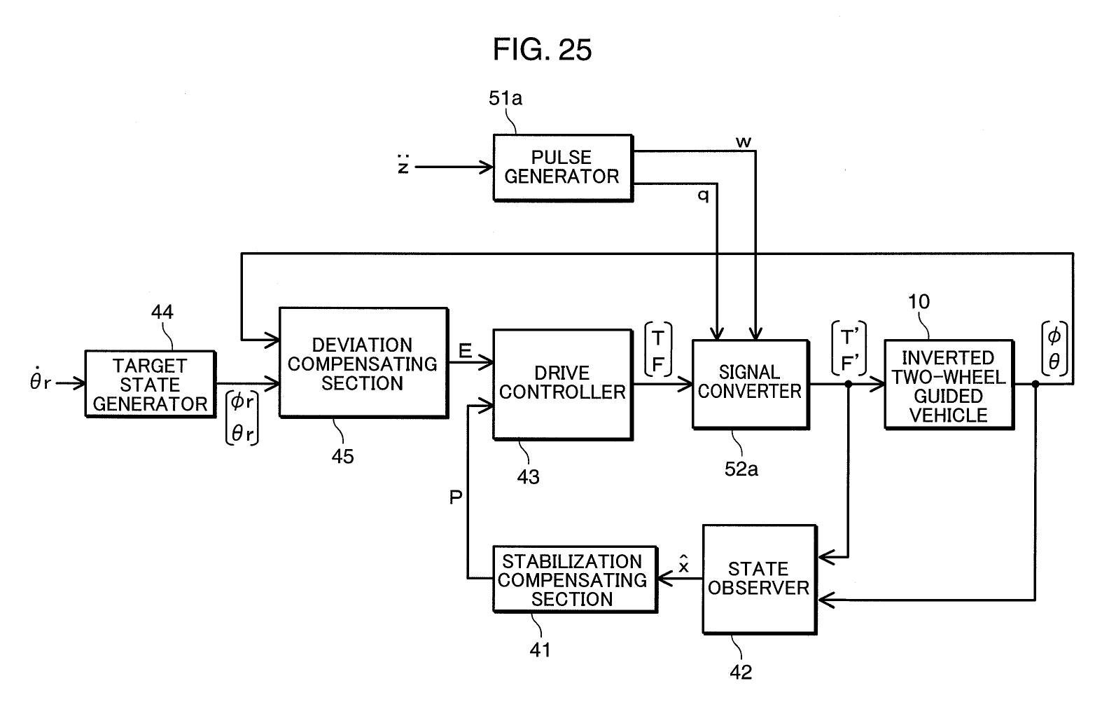

The controller used in this embodiment is not particularly limited to the above example and various changes can be made. For example, a controller described below may also be used. FIG. 25 is a block diagram showing another example of the controller of the inverted two-wheel guided vehicle in the second embodiment of the present invention. In FIG. 25, the same constituent elements as in the FIG. 5 are identified by the same reference numerals and not repeatedly described.

An inverted two-wheel guided vehicle 10 of this example also executes a control for a vertical displacement such as the one caused by a step present in a travel path using a controller 9 shown in FIG. 25 and the vertical acceleration sensor 13 shown in FIG. 2. Specifically, the vertical acceleration sensor 13 constituting the vertical acceleration detector is mounted in the inverted two-wheel guided vehicle 10. For example, when the inverted two-wheel guided vehicle 10 climbs onto and descends from a step present in a travel path, the vertical acceleration sensor 13 detects the vertical acceleration of the carriage 5 and outputs an acceleration signal z″.

In FIG. 25, the acceleration signal z″ is inputted to a pulse generator 51a and the pulse generator 51a measures the magnitude of the inputted acceleration signal z″ and outputs a pulse signal w to a signal converter 52a when a change of vertical acceleration exceeds a specified value. Simultaneously, the pulse generator 51a outputs a polarity signal q to the signal converter 52a when the polarity of the inputted acceleration signal z″ is negative.

Specifically, when the inverted two-wheel guided vehicle 10 descends from the step, the pulse generator 51a outputs the pulse signal w and the polarity signal q to the signal converter 52a. On the other hand, when the inverted two-wheel guided vehicle 10 climbs up the step, the pulse generator 51a outputs only the pulse signal w to the signal converter 52a.

A torque command T and a thrust command F generated by the drive controller 43 are inputted to the signal converter 52a, and the signal converter 52a outputs a converted torque command T′ and a converted thrust command F′ converted according to the pulse signal w and the polarity signal q to the inverted two-wheel guided vehicle 10 (first actuators 3a, 3b and second actuator 11).

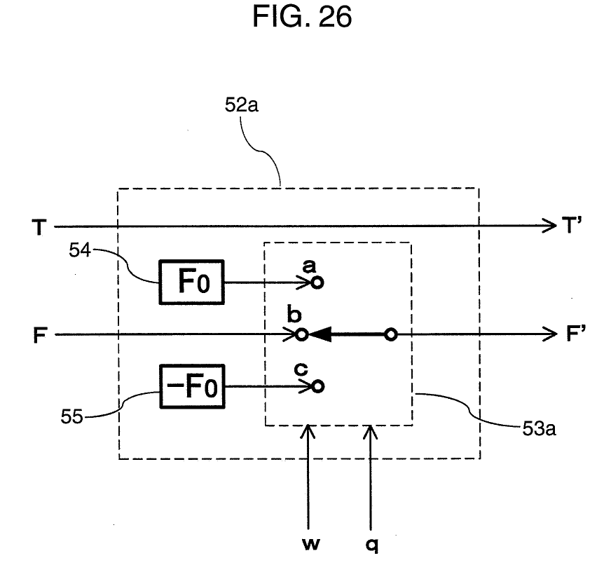

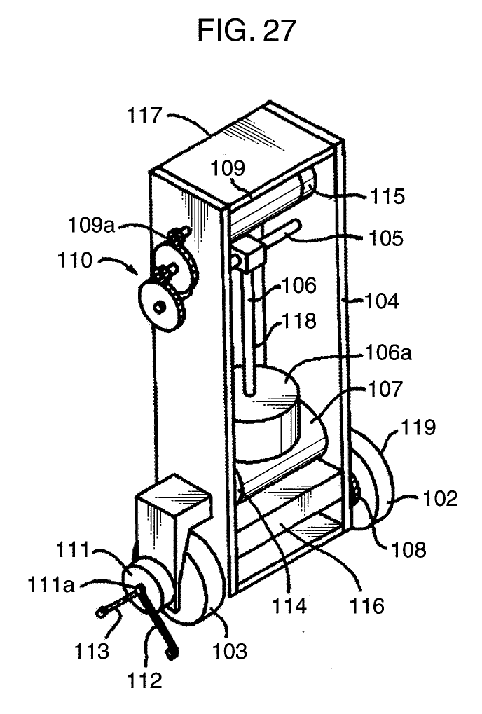

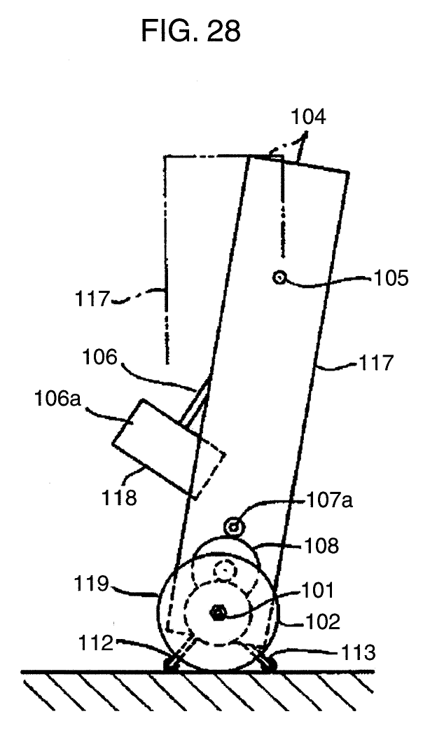

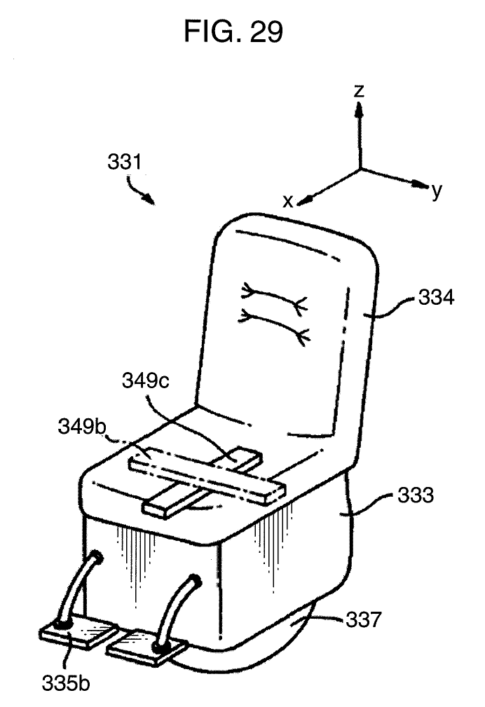

FIG. 26 is a block diagram showing a more specific example of the signal converter 52a constituting the controller shown in FIG. 25. In FIG. 26, the torque command T inputted from the drive controller 43 is directly outputted as the converted torque command T′ to the inverted two-wheel guided vehicle 10 (first actuators 3a, 3b). The thrust command F inputted from the drive controller 43 is outputted as the converted thrust command F′ to the inverted two-wheel guided vehicle 10 (second actuator 11) via a changeover switch 53a. An output terminal of the changeover switch 53a is connected with a terminal “a”, a terminal “b” or a terminal “c” depending on the pulse signal w and the polarity signal q outputted from the pulse generator 51a.

For example, when the inverted two-wheel guided vehicle 10 climbs up the step, the pulse generator 51a outputs only the pulse signal w to the changeover switch 53a to switch the changeover switch 53a to the terminal “a”. At this time, the thrust command F inputted from the drive controller 43 is not outputted to the inverted two-wheel guided vehicle 10 (second actuator 11) and a constant value FO generated by the signal generator 54 is outputted as the converted thrust command F′.

On the other hand, when the inverted two-wheel guided vehicle 10 descends from the step, the pulse generator 51a outputs the pulse signal w and the polarity signal q to the changeover switch 53a to switch the changeover switch 53a to the terminal “c”. At this time, the thrust command F inputted from the drive controller 43 is not outputted to the inverted two-wheel guided vehicle 10 (second actuator 11) and a constant value (−FO) generated by the signal generator 54 is outputted as the converted thrust command F′.

Further, when the inverted two-wheel guided vehicle 10 does not pass the step, the pulse generator 51a does not output the pulse signal w to the changeover switch 53a, the output terminal of the changeover switch 53a is connected with the terminal “b” and the thrust command F inputted from the drive controller 43 is directly outputted as the converted thrust command F′ to the inverted two-wheel guided vehicle 10 (second actuator 11).

As described above, when the inverted two-wheel guided vehicle 10 climbs up and descends from a step present in a travel path or the like, the vertical acceleration sensor 13 detects the vertical acceleration and the signal generator 52 converts the thrust command F and outputs the converted thrust command F′ to the inverted two-wheel guided vehicle 10 (second actuator 11).

As described above, the controller shown in FIG. 25 holds the posture of the vehicle body 4 in equilibrium by giving proper torque command T and converted thrust command F′ to the first actuators 3a, 3b and the second actuator 11. Further, the controller detects the vertical acceleration by means of the vertical acceleration sensor 13 and executes a control for a vertical displacement such as the one caused by a step present in a travel path. As a result, even with the inverted two-wheel guided vehicle 10 using the vertical acceleration sensor 13 and the controller shown in FIG. 25, a simulation result on the step moving-over operation is similar to the one shown in FIG. 23A trough FIG. 23E.

Specifically, when the inverted two-wheel guided vehicle 10 reaches the step shown in FIG. 15 at time t2 and the vertical acceleration sensor 13 detects the vertical acceleration as shown in FIG. 23A trough FIG. 23E, the pulse generator 51a outputs a pulse signal was shown in FIG. 24 to the signal converter 52a. The pulse width of the pulse signal w of FIG. 24 is assumed to be, for example. 0.5 sec.

The pulse signal w inputted to the signal converter 52a causes the changeover switch 53a to be switched to the terminal “a” and the thrust command F inputted from the drive controller 43 is shut off from the control system. The thrust F of the second actuator 11 acting on the moving mechanism 7 becomes the constant value FO generated by the signal generator 54. In the examples of FIG. 23A trough FIG. 23E, the constant value FO generated by the signal generator 54 is zero and the thrust F of the second actuator 11 acting on the moving mechanism 7 is zero as shown in FIG. 23E.

Further, even if the thrust F of the second actuator 11 is zero when the inverted two-wheel guided vehicle 10 reaches the step shown in FIG. 15 at time t2, the vehicle body 4 is displaced only by about 10 cm as the relative displacement amount δ in the traveling direction due to an inertial force as shown in FIG. 23C. Since the vehicle body 4 is largely displaced in the traveling direction in this way, it tries to make a forward inclining movement in the traveling direction.

On the other hand, since the rotational torque T of the wheels 1a, 1b constitutes the control system even during the step moving-over operation at time t2, the posture of the vehicle body 4 is controlled and the rotational torque T is increased in a direction to move over the step as shown in FIG. 23D so that the vehicle body 4 is not inclined forward. By the reaction of this rotational torque T, the vehicle body 4 is inclined in a direction opposite to the traveling direction as shown in FIG. 23B, but the angle of inclination φ is suppressed to −5°. As a result, the inverted two-wheel guided vehicle 10 momentarily stops at the position of the step in the case of FIG. 23A trough FIG. 23E, but can more smoothly move over the step as compared with the case of FIG. 22A trough FIG. 22E.

As described above, in this example, the vertical acceleration sensor 13 constituting the vertical acceleration detector detects the vertical acceleration, whereby the step arriving timing of the inverted two-wheel guided vehicle 10 is detected and the pulse signal w is outputted to the signal converter 52a. The pulse signal w causes the changeover switch 53a of the signal converter 52a to be connected with the terminal “a” and outputs the constant value FO (FO=0 in this case). At this time, the thrust F of the second actuator 11 is zeroed, the moving mechanism 7 is displaced in the traveling direction of the vehicle body 4 by the inertial force and the rotational torque T of the wheels 1a, 1b is increased for the step moving-over operation. Thus, the kinetic energy of the moving speed v effectively acts for the step moving-over operation and the rotational torque T of the wheels 1a, 1b necessary for this operation is sufficient to be a torque smaller than the one shown in FIG. 22D.

Although the simulation is conducted for the step climbing-up operation in the above description, the inverted two-wheel guided vehicle 10 of this embodiment can move over the step while horizontally maintaining the loading platform by the action of the vertical acceleration sensor 13 and the moving mechanism 7 not only upon climbing up the step, but also upon descending from the step.

For example, when the inverted two-wheel guided vehicle 10 climbs up the step, the pulse generator 51a outputs only the pulse signal w to the signal converter 52a and the constant value FO (FO>0) generated by the signal generator 54 is inputted as the converted thrust command F′ to the moving mechanism 7 of the inverted two-wheel guided vehicle 10. As a result, upon climbing up the step, the step can be passed while the seat 8 is horizontally held by displacing the vehicle body 4 in the traveling direction with respect to the carriage 5.

On the other hand, when the inverted two-wheel guided vehicle 10 descends from the step, the pulse generator 51a outputs the pulse signal w and the polarity signal q to the signal converter 52a, and the constant value (−FO) (FO>0) generated by a signal generator 55 is inputted as the converted thrust command F′ to the moving mechanism 7 of the inverted two-wheel guided vehicle 10. As a result, upon descending from the step, the step can be passed while the seat 8 is horizontally maintained by displacing the vehicle body 4 in a direction opposite to the traveling direction with respect to the carriage 5.

Although the signals generated by the signal generators 54, 55 have different polarities in the example of the signal converter 52a of FIG. 26, but the magnitudes thereof are equal, the magnitudes of the signals generated by the signal generators 54, 55 may differ.

In the example of the pulse generator 51a of FIG. 25, the two signals of the pulse signal w and the polarity signal q are outputted depending on the inputted acceleration signal z″, so that the center of gravity position of the entire vehicle body 4 loaded with baggage or a person is forcibly moved forward or backward with respect to the traveling direction when the inverted two-wheel guided vehicle 10 climbs up or descends from the step.

However, if it is only an important task that the inverted two-wheel guided vehicle 10 climbs up the step, the pulse generator 51a of FIG. 25 may output the pulse signal w depending on the acceleration signal z″ only when the inverted two-wheel guided vehicle 10 climbs up the step and the constant value FO generated by the signal generator 54 is inputted as the converted thrust command F′ to the moving mechanism 7 to forcibly move the vehicle body 4 forward in the traveling direction with respect to the carriage 5. In such a case, the pulse generator 51a of FIG. 25 needs not generate the polarity signal q and the signal converter 52a of FIG. 25 requires neither the signal generator 55 nor the terminal “c” of the changeover switch 53a, wherefore the constructions of the pulse generator 51a and the signal converter 52a can be simplified.

As is clear from the above description, in this example, a control is executed for a vertical displacement such as the one caused by a step present in a travel path by providing the vertical acceleration sensor 13 for detecting the vertical acceleration of the carriage 5. As a result, the inverted two-wheel guided vehicle 10 of this example can move the center of gravity position of the entire vehicle body 4 loaded with baggage or a person forward or backward with respect to the traveling direction upon a step moving-over operation which has been difficult to perform with the conventional inverted two-wheel guided vehicle. Therefore, there is an effect of being able to more smoothly move over the step in a stable posture.

In FIG. 21 and FIG. 23A trough FIG. 23E, when the vertical acceleration sensor 13 for detecting the vertical acceleration detects the vertical acceleration and the pulse generator 51 outputs the pulse signal w to the signal converter 52, a constant value having a magnitude of zero is outputted only for a period of 0.5 sec. as the converted thrust command F′. However, it goes without saying that a pulsed thrust of a constant value having a magnitude other than zero may be outputted or that a pulsed thrust of a constant value may be generated in the second actuator by changing the pulse width. Further, the magnitude and pulse width of the pulsed thrust to act on the second actuator 11 may be changed according to the magnitude of the moving speed v immediately before the inverted two-wheel guided vehicle 10 reaches the step and the magnitude of the acceleration signal z″ in the vertical direction the vehicle body 4 receives during the step moving-over operation.

Although only one integrator is included in the deviation compensator for the sake of simplification in the block diagram, in which the angle of rotation deviation θe is processed, in the above description, double integration may be performed by connecting two integrators in series similar to the block diagram in which the angle of inclination deviation φe is processed. It goes without saying that an uphill or downhill operation can be performed in this case as well while the loading platform loaded with baggage or a person is horizontally held by automatically moving the center of gravity position of the entire vehicle body 4.

Although the gyro sensor is used as the inclination sensor for detecting the inclined posture of the vehicle body 4 in the above description, various sensors usable for the measurement of an angle of inclination and an inclination angular velocity such as an acceleration sensor, an inclination angle sensor of the type including a contact piece slidable on a floor surface and an inclination angle sensor with a hanging weight can also be used without being limited to the above sensor. Further, the mounted position of the sensor is not particularly limited to the vehicle body 4 and the sensor may be mounted in the carriage 5.

Although the deviation compensator is described to be constructed by an analog filter, it can be also constructed by a digital filter. Further, the respective parts constituting the control systems of the respective embodiments may be realized by software by means of a microcomputer.

The present invention is summarized as follows from the above respective embodiments. Specifically, an inverted two-wheel guided vehicle according to the present invention comprises a vehicle body including a loading platform capable of carrying baggage or a person; a carriage supported on two wheels coaxially arranged while being spaced apart; a moving mechanism provided between the vehicle body and the carriage for displacing relative positions of the vehicle body and the carriage in a traveling direction of the carriage; an inclination detector for detecting the posture of the vehicle body with respect to a vertical direction; a travel detector for detecting a traveling state of the carriage; a first actuator for causing the two wheels to respectively generate rotational forces; a second actuator for causing the vehicle body to generate a thrust via the moving mechanism; a drive controller for outputting a torque command and a thrust command to the first actuator and the second actuator; a target commanding section for generating a target command value for at least one of the position and speed of the carriage; a deviation compensating section, to which the target command value and detection signals of the inclination detector and the travel detector are inputted to generate a deviation compensation signal based on a deviation between the target command value and the detection signals; and a stabilization compensating section, to which at least the respective detection signals of the inclination detector and the travel detector are inputted to generate a stabilization signal used to control the posture of the vehicle body, wherein the deviation compensating section generates the deviation compensation signal using a processing of at least doubly integrating a signal based on the detection signal of the inclination detector with respect to time; and the drive controller generates the torque command and the thrust command in accordance with the deviation compensation signal and the stabilization signal.

In this inverted two-wheel guided vehicle, the deviation compensation signal is generated using the processing of at doubly integrating the signal based on the detection signal of the inclination detector with respect to time, and the torque command to the first actuator and the thrust command to the second actuator are generated from this deviation compensation signal and the stabilization signal used to control the posture of the vehicle body. Thus, it is possible to automatically move the center of gravity position of the entire vehicle body loaded with baggage or a person to the position of an axle within a movable range of the moving mechanism and maintain the horizontal balance of the loading platform regardless of the weight of the baggage or person loaded on the loading platform and how far the center of gravity of the loading platform is displaced from the center of gravity position of the vehicle body. Accordingly, the loading platform loaded with baggage or a person can be moved while being constantly horizontally held also upon climbing up and down a slope. Therefore, no discomfort is given to the loaded person, and lateral sliding of loaded baggage or collapse of baggage piles can be prevented. By providing the moving mechanism, the center of gravity position of the entire vehicle body loaded with the baggage or person can be moved forward in the traveling direction even if a step is present in a travel path. Thus, the step can be moved over in a stable posture. There are additional effects of requiring no special weight or counterweight to hold the loading platform in equilibrium and not increasing the weight and size of the vehicle body.

The deviation compensating section preferably includes a first integrator for integrating the signal based on the detection signal of the inclination detector, a second integrator for further integrating an output of the first integrator, a first multiplier for multiplying the output of the first integrator by a first coefficient, a second multiplier for multiplying an output of the second integrator by a second coefficient and an adder for adding an output of the first multiplier and that of the second multiplier; and outputs an addition result of the adder while including it in the deviation compensation signal.

In this case, the signal based on the detection signal of the inclination detector is integrated and this output is further integrated, whereby the signal based on the detection signal of the inclination detector can be at least doubly integrated with respect to time. The signal obtained by multiplying this doubly integrated signal by the second coefficient and the signal obtained by multiplying the integrated signal of the signal based on the detection signal of the inclination detector by the first coefficient are added. Thus, the signal obtained by at least doubly integrating the signal based on the detection signal of the inclination detector with respect to time can be outputted while being included in the deviation compensation signal. Accordingly, the vehicle body is not inclined forward and the moving mechanism is horizontally held even during an uphill operation and a downhill operation, wherefore it is not necessary to maintain a displacement by constantly generating a thrust in the second actuator against a gravitational force acting on the vehicle body and the loading platform loaded with the baggage or person can be moved while being constantly horizontally held. As a result, no discomfort is given to the person, lateral sliding of the baggage or collapse of baggage piles can be prevented and power consumption for the driving can be reduced.

It is preferable that the above inverted two-wheel guided vehicle further comprises a vertical acceleration detector for detecting vertical acceleration of the carriage; and that the drive controller controls a rotational torque of the first actuator and a thrust of the second actuator in accordance with the detection signal of the inclination detector and the detection signal of the travel detector and adjusts the thrust of the second actuator according to the magnitude of the acceleration detected by the vertical acceleration detector.

In this case, a vertical displacement such as the one caused by a step present in a travel path can be controlled by further comprising the vertical acceleration detector for detecting the vertical acceleration of the carriage. Therefore, the step can be more smoothly moved over in a stable posture.

The stabilization compensating section preferably includes a state observer, to which at least the respective detection signals of the inclination detector and the travel detector, the torque command and the thrust command are inputted to estimate state variables undetectable by the inclination detector and the travel detector.

In this case, since the state variables undetectable by the inclination detector and the travel detector can be estimated from the respective detection signals of the inclination detector and the travel detector, the torque command and the thrust command, it is not necessary to especially provide sensors for detecting the state variables undetectable using the inclination detector and the travel detector and a cost reduction of the guided vehicle can be promoted.

The inclination detector preferably detects at least one of an angle of inclination and an inclination angular velocity of the vehicle body with respect to the vertical direction. Further, the travel detector preferably detects at least one of an angle of rotation, a rotational angular velocity and a rotational angular acceleration of the two wheels.

In this case, since undetected other state variables can be estimated from the detected state variables, it is not necessary to especially provide sensors for detecting the undetected state variables and a cost reduction of the guided vehicle can be promoted.

Another inverted two-wheel guided vehicle according to the present invention comprises a vehicle body including a loading platform capable of carrying baggage or a person; a carriage supported on two wheels coaxially arranged while being spaced apart; a moving mechanism provided between the vehicle body and the carriage for displacing relative positions of the vehicle body and the carriage in a traveling direction of the carriage; an inclination detector for detecting the posture of the vehicle body with respect to a vertical direction; a travel detector for detecting a traveling state of the carriage; a vertical acceleration detector for detecting vertical acceleration of the carriage; a first actuator for causing the two wheels to respectively generate rotational forces; a second actuator for causing the vehicle body to generate a thrust via the moving mechanism; and a controller for outputting a torque command and a thrust command to the first actuator and the second actuator, wherein the controller controls a rotational torque of the first actuator and a thrust of the second actuator according to a detection signal of the inclination detector and a detection signal of the travel detector and adjusts the thrust of the second actuator according to the magnitude of the acceleration detected by the vertical acceleration detector.

In this inverted two-wheel guided vehicle, the rotational torque of the first actuator and the thrust of the second actuator are controlled in accordance with the detection signals of the inclination detector and the travel detector and the thrust of the second actuator is adjusted according to the magnitude of the acceleration detected by the vertical acceleration detector. Thus, a control can be executed for a vertical displacement such as the one caused by a step in a travel path and the step can be more smoothly moved over in a stable posture by further comprising the vertical acceleration detector for detecting the vertical acceleration of the carriage.

The controller preferably includes a target commanding section for generating a target command value for at least one of the position and speed of the carriage; a deviation compensating section, to which the target command value and the respective detection signals of the inclination detector and the travel detector are inputted to generate a deviation compensation signal based on deviation between the target command value and the detection signals; a stabilization compensating section, to which at least the respective detection signals of the inclination detector and the travel detector are inputted to generate a stabilization signal used to control the posture of the vehicle body; and a drive controller for outputting the torque command and the thrust command according to an output of the inclination detector and an output of the travel detector.

In this case, the target command value for at least one of the position and speed of the carriage is generated, the deviation compensation signal is generated based on the deviation between this target command value and the detection signals of the inclination detector and the travel detector, the stabilization signal used to control the posture of the vehicle body is generated at least from the respective detection signals of the inclination detector and the travel detector, and the torque command and the thrust command are outputted according to the output of the inclination detector and that of the travel detector. Thus, a control can be more stably executed for a vertical displacement such as the one caused by a step present in a travel path and the step can be more smoothly moved over in a more stable posture.

The controller preferably displaces the vehicle body in the traveling direction with respect to the carriage at the time of climbing up a step and displaces the vehicle body in a direction opposite to the traveling direction with respect to the carriage at the time of climbing down the step according to the acceleration detected by the vertical acceleration detector.

In this case, the vehicle body is displaced in the traveling direction with respect to the carriage at the time of climbing up the step and displaced in the direction opposite to the traveling direction with respect to the carriage at the time of climbing down the step according to the detected acceleration. Thus, the step can be more smoothly moved over in a more stable posture.

The deviation compensating section preferably generates the deviation compensation signal using a processing of at least doubly integrating the signal based on the detection signal of the inclination detector with respect to time.

In this case, the deviation compensation signal is generated using the processing of at least doubly integrating the signal based on the detection signal of the inclination detector with respect to time, and the torque command to the first actuator and the thrust command to the second actuator are generated from this deviation compensation signal and the stabilization signal used to control the posture of the vehicle body. Thus, it is possible to automatically move the center of gravity position of the entire vehicle body loaded with baggage or a person to the position of an axle within a movable range of the moving mechanism and maintain the horizontal balance of the loading platform regardless of the weight of the baggage or person loaded on the loading platform and how far the center of gravity of the loading platform is displaced from the center of gravity position of the vehicle body.

The stabilization compensating section preferably includes a state observer, to which at least the respective detection signals of the inclination detector and the travel detector, the torque command and the thrust command are inputted to estimate state variables undetectable by the inclination detector and the travel detector.

In this case, since the state variables undetectable by the inclination detector and the travel detector can be estimated from the respective detection signals of the inclination detector and the travel detector, the torque command and the thrust command, it is not necessary to especially provide sensors for detecting the state variables undetectable using the inclination detector and the travel detector and a cost reduction of the guided vehicle can be promoted.

The controller preferably causes the second actuator to generate a pulsed thrust depending on the magnitude of the acceleration detected by the vertical acceleration detector.

In this case, the second actuator is caused to generate the pulsed thrust depending on the magnitude of the detected acceleration, whereby a control can be executed for a vertical displacement and steps of various heights can be moved over in stable postures.

The controller preferably causes the second actuator to generate a pulsed thrust when the magnitude of the acceleration detected by the vertical acceleration detector exceeds a specified value.

In this case, the second actuator is caused to generate the pulsed thrust when the magnitude of the acceleration detected by the vertical acceleration detector exceeds the specified value, whereby a control can be executed for a vertical displacement and a step of a specified height or higher can be moved over in a stable posture.

A crest value and a duration of the pulsed thrust are preferably changed according to the magnitude of a moving speed of the carriage before the pulse is generated.

In this case, since the crest value and the duration of the pulsed thrust are changed according to the magnitude of the moving speed of the carriage before the pulse is generated, a control suitable for the moving speed of the carriage can be executed for a vertical displacement and the step can be constantly moved over in a stable posture even if the moving speed of the carriage differs.

The magnitude of the pulsed thrust is preferably zero.

In this case, the step can be moved over by displacing the vehicle body in the traveling direction by an inertial force and increasing the rotational torque of the wheels. Thus, the kinetic energy of the moving speed can effectively act for the step moving-over operation and the rotational torque of the wheels necessary for this operation can be sufficiently reduced.

The inclination detector preferably detects at least one of an angle of inclination and an inclination angular velocity of the vehicle body with respect to the vertical direction.

In this case, since undetected other state variables can be estimated from the detected state variable, it is not necessary to especially provide sensors for detecting the undetected state variables and a cost reduction of the guided vehicle can be promoted.

A method for controlling an inverted two-wheel guided vehicle according to the present invention is a method for controlling an inverted two-wheel guided vehicle comprising a vehicle body including a loading platform capable of carrying baggage or a person; a carriage supported on two wheels coaxially arranged while being spaced apart; a moving mechanism provided between the vehicle body and the carriage for displacing relative positions of the vehicle body and the carriage in a traveling direction of the carriage; an inclination detector for detecting the posture of the vehicle body with respect to a vertical direction; a travel detector for detecting a traveling state of the carriage; a first actuator for causing the two wheels to respectively generate rotational forces; a second actuator for causing the vehicle body to generate a thrust via the moving mechanism; a drive controller for outputting a torque command and a thrust command to the first actuator and the second actuator; a target commanding section for generating a target command value; a deviation compensating section for generating a deviation compensation signal; and a stabilization compensating section for generating a stabilization signal, the method comprising a step in which the target commanding section generates a target command value for at least one of the position and speed of the carriage; a step in which the target command value and detection signals of the inclination detector and the travel detector are inputted to the deviation compensating section and the deviation compensating section generates a deviation compensation signal using a processing of at least doubly integrating a signal based on the detection signal of the inclination detector with respect to time based on a deviation between the target command value and the detection signals of the inclination detector and the travel detector; a step in which at least the respective detection signals of the inclination detector and the travel detector are inputted to the stabilization compensating section and the stabilization compensating section generates a stabilization signal used to control the posture of the vehicle body; and a step in which the drive controller generates the torque command and the thrust command in accordance with the deviation compensation signal and the stabilization signal.

Another method for controlling an inverted two-wheel guided vehicle according to the present invention is a method for controlling an inverted two-wheel guided vehicle comprising a vehicle body including a loading platform capable of carrying baggage or a person; a carriage supported on two wheels coaxially arranged while being spaced apart; a moving mechanism provided between the vehicle body and the carriage for displacing relative positions of the vehicle body and the carriage in a traveling direction of the carriage; an inclination detector for detecting the posture of the vehicle body with respect to a vertical direction; a travel detector for detecting a traveling state of the carriage; a vertical acceleration detector for detecting vertical acceleration of the carriage; a first actuator for causing the two wheels to respectively generate rotational forces; a second actuator for causing the vehicle body to generate a thrust via the moving mechanism; and a controller for outputting a torque command and a thrust command to the first actuator and the second actuator, the method comprising a step in which the controller generates a target command value for at least of the position and speed of the carriage; a step in which the respective detection signals of the inclination detector and the travel detector are inputted to the controller and the controller generates a deviation compensation signal based on a deviation between the target command value and the respective detection signals of the inclination detector and the travel detector; a step in which the controller generates a stabilization signal used to control the posture of the vehicle body at least from the respective detection signals of the inclination detector and the travel detector; and a step in which the controller generates the torque command and the thrust command based on the deviation compensation signal and the stabilization signal and adjusts the thrust of the second actuator according to the magnitude of the acceleration detected by the vertical acceleration detector.

### INDUSTRIAL APPLICABILITY

An inverted two-wheel guided vehicle and a control method therefor according to the present invention enable the travel in a stable posture while a loading platform loaded with a heavy load such as baggage or a person is constantly horizontally held even upon climbing up and down a slope and further enable the travel to move over a step in a stable posture even if the step is present in a travel path of the inverted two-wheel guided vehicle. Thus, these inverted two-wheel guided vehicle and control method are useful for inverted two-wheel guided vehicles designed to transport baggage or a person and provided with mechanism technology and control technology for stably transporting the baggage or person while holding a vehicle body, which is originally unstable, in equilibrium, and are also applicable to vehicles, robots and the like using an equilibrium behavior by a control besides inverted two-wheel guided vehicles.

1. An inverted two-wheel guided vehicle, comprising:
a vehicle body including a loading platform capable of carrying baggage or a person;
a carriage supported on two wheels coaxially arranged while being spaced apart;
a moving mechanism provided between the vehicle body and the carriage for displacing relative positions of the vehicle body and the carriage in a traveling direction of the carriage;
an inclination detector for detecting the posture of the vehicle body with respect to a vertical direction;
a travel detector for detecting a traveling state of the carriage;
a first actuator for causing the two wheels to respectively generate rotational forces;
a second actuator for causing the vehicle body to generate a thrust via the moving mechanism;
a drive controller for outputting a torque command and a thrust command to the first actuator and the second actuator;
a target commanding section for generating a target command value for at least one of the position and speed of the carriage;
a deviation compensating section, to which the target command value and detection signals of the inclination detector and the travel detector are inputted to generate a deviation compensation signal based on a deviation between the target command value and the detection signals; and
a stabilization compensating section, to which at least the respective detection signals of the inclination detector and the travel detector are inputted to generate a stabilization signal used to control the posture of the vehicle body,
wherein:
the deviation compensating section generates the deviation compensation signal using a processing of at least doubly integrating a signal based on the detection signal of the inclination detector with respect to time; and
the drive controller generates the torque command and the thrust command in accordance with the deviation compensation signal and the stabilization signal.

2. An inverted two-wheel guided vehicle according to claim 1, wherein the deviation compensating section includes:
a first integrator for integrating the signal based on the detection signal of the inclination detector,
a second integrator for further integrating an output of the first integrator,
a first multiplier for multiplying the output of the first integrator by a first coefficient,
a second multiplier for multiplying an output of the second integrator by a second coefficient, and
an adder for adding an output of the first multiplier and that of the second multiplier; and
outputs an addition result of the adder while including it in the deviation compensation signal.

3. An inverted two-wheel guided vehicle according to claim 1, further comprising a vertical acceleration detector for detecting vertical acceleration of the carriage,
wherein the drive controller controls a rotational torque of the first actuator and a thrust of the second actuator in accordance with the detection signal of the inclination detector and the detection signal of the travel detector and adjusts the thrust of the second actuator according to the magnitude of the acceleration detected by the vertical acceleration detector.

4. An inverted two-wheel guided vehicle according to claim 1, wherein the stabilization compensating section includes a state observer, to which at least the respective detection signals of the inclination detector and the travel detector, the torque command and the thrust command are inputted to estimate state variables undetectable by the inclination detector and the travel detector.

5. An inverted two-wheel guided vehicle according to claim 1, wherein the inclination detector detects at least one of an angle of inclination and an inclination angular velocity of the vehicle body with respect to the vertical direction.

6. An inverted two-wheel guided vehicle according to claim 1, wherein the travel detector detects at least one of an angle of rotation, a rotational angular velocity and a rotational angular acceleration of the two wheels.

7. An inverted two-wheel guided vehicle, comprising:
a vehicle body including a loading platform capable of carrying baggage or a person;
a carriage supported on two wheels coaxially arranged while being spaced apart;
a moving mechanism provided between the vehicle body and the carriage for displacing relative positions of the vehicle body and the carriage in a traveling direction of the carriage;
an inclination detector for detecting the posture of the vehicle body with respect to a vertical direction;
a travel detector for detecting a traveling state of the carriage;
a vertical acceleration detector for detecting vertical acceleration of the carriage;
a first actuator for causing the two wheels to respectively generate rotational forces;
a second actuator for causing the vehicle body to generate a thrust via the moving mechanism; and
a controller for outputting a torque command and a thrust command to the first actuator and the second actuator,
wherein the controller controls a rotational torque of the first actuator and a thrust of the second actuator according to a detection signal of the inclination detector and a detection signal of the travel detector and adjusts the thrust of the second actuator according to the magnitude of the acceleration detected by the vertical acceleration detector.

8. An inverted two-wheel guided vehicle according to claim 7, wherein the controller includes:
a target commanding section for generating a target command value for at least one of the position and speed of the carriage;
a deviation compensating section, to which the target command value and the respective detection signals of the inclination detector and the travel detector are inputted to generate a deviation compensation signal based on deviation between the target command value and the detection signals;
a stabilization compensating section, to which at least the respective detection signals of the inclination detector and the travel detector are inputted to generate a stabilization signal used to control the posture of the vehicle body; and
a drive controller for outputting the torque command and the thrust command according to an output of the inclination detector and an output of the travel detector.

9. An inverted two-wheel guided vehicle according to claim 7, wherein the controller displaces the vehicle body in the traveling direction with respect to the carriage at the time of climbing up a step and displaces the vehicle body in a direction opposite to the traveling direction with respect to the carriage at the time of climbing down the step according to the acceleration detected by the vertical acceleration detector.

10. An inverted two-wheel guided vehicle according to claim 7, wherein the deviation compensating section generates the deviation compensation signal using a processing of at least doubly integrating the signal based on the detection signal of the inclination detector with respect to time.

11. An inverted two-wheel guided vehicle according to claim 7, wherein the stabilization compensating section includes a state observer, to which at least the respective detection signals of the inclination detector and the travel detector, the torque command and the thrust command are inputted to estimate state variables undetectable by the inclination detector and the travel detector.

12. An inverted two-wheel guided vehicle according to claim 7, wherein the controller causes the second actuator to generate a pulsed thrust depending on the magnitude of the acceleration detected by the vertical acceleration detector.

13. An inverted two-wheel guided vehicle according to claim 7, wherein the controller causes the second actuator to generate a pulsed thrust when the magnitude of the acceleration detected by the vertical acceleration detector exceeds a specified value.

14. An inverted two-wheel guided vehicle according to claim 12, wherein a crest value and a duration of the pulsed thrust are changed according to the magnitude of a moving speed of the carriage before the pulse is generated.

15. An inverted two-wheel guided vehicle according to claim 12, wherein the magnitude of the pulsed thrust is zero.

16. An inverted two-wheel guided vehicle according to claim 7, wherein the inclination detector detects at least one of an angle of inclination and an inclination angular velocity of the vehicle body with respect to the vertical direction.

17. A method for controlling an inverted two-wheel guided vehicle comprising a vehicle body including a loading platform capable of carrying baggage or a person; a carriage supported on two wheels coaxially arranged while being spaced apart; a moving mechanism provided between the vehicle body and the carriage for displacing relative positions of the vehicle body and the carriage in a traveling direction of the carriage; an inclination detector for detecting the posture of the vehicle body with respect to a vertical direction; a travel detector for detecting a traveling state of the carriage; a first actuator for causing the two wheels to respectively generate rotational forces; a second actuator for causing the vehicle body to generate a thrust via the moving mechanism; a drive controller for outputting a torque command and a thrust command to the first actuator and the second actuator; a target commanding section for generating a target command value; a deviation compensating section for generating a deviation compensation signal; and a stabilization compensating section for generating a stabilization signal,
the method comprising:
a step in which the target commanding section generates a target command value for at least one of the position and speed of the carriage;
a step in which the target command value and detection signals of the inclination detector and the travel detector are inputted to the deviation compensating section and the deviation compensating section generates a deviation compensation signal using a processing of at least doubly integrating a signal based on the detection signal of the inclination detector with respect to time based on a deviation between the target command value and the detection signals of the inclination detector and the travel detector;
a step in which at least the respective detection signals of the inclination detector and the travel detector are inputted to the stabilization compensating section and the stabilization compensating section generates a stabilization signal used to control the posture of the vehicle body; and
a step in which the drive controller generates the torque command and the thrust command in accordance with the deviation compensation signal and the stabilization signal.

18. A method for controlling an inverted two-wheel guided vehicle comprising a vehicle body including a loading platform capable of carrying baggage or a person; a carriage supported on two wheels coaxially arranged while being spaced apart; a moving mechanism provided between the vehicle body and the carriage for displacing relative positions of the vehicle body and the carriage in a traveling direction of the carriage; an inclination detector for detecting the posture of the vehicle body with respect to a vertical direction; a travel detector for detecting a traveling state of the carriage; a vertical acceleration detector for detecting vertical acceleration of the carriage; a first actuator for causing the two wheels to respectively generate rotational forces; a second actuator for causing the vehicle body to generate a thrust via the moving mechanism; and a controller for outputting a torque command and a thrust command to the first actuator and the second actuator,
the method comprising:
a step in which the controller generates a target command value for at least of the position and speed of the carriage;
a step in which the respective detection signals of the inclination detector and the travel detector are inputted to the controller and the controller generates a deviation compensation signal based on a deviation between the target command value and the respective detection signals of the inclination detector and the travel detector;
a step in which the controller generates a stabilization signal used to control the posture of the vehicle body at least from the respective detection signals of the inclination detector and the travel detector; and
a step in which the controller generates the torque command and the thrust command based on the deviation compensation signal and the stabilization signal and adjusts the thrust of the second actuator according to the magnitude of the acceleration detected by the vertical acceleration detector.
